(19) United States
(12) Patent Application Publication
(10) Pub. No.: US 2023/0184643 A1
(43) Pub. Date: Jun. 15, 2023

(54) METHOD FOR MEASURING OR IDENTIFYING A COMPONENT OF INTEREST IN SPECIMENS

(71) Applicants: SHIMADZU CORPORATION, Kyoto-shi, Kyoto (JP); JP SCIENTIFIC LIMITED, Waterloo (CA)

(72) Inventors: Janusz B. PAWLISZYN, Waterloo (CA); Milaan THIRUKUMARAN, Waterloo (CA); Varoon SINGH, Waterloo (CA); Yohei ARAO, Columbia, MD (US); Yuka FUJITO, Columbia, MD (US); Masayuki NISHIMURA, Columbia, MD (US); Tairo OGURA, Kyoto-shi (JP)

(73) Assignees: SHIMADZU CORPORATION, Kyoto-shi, Kyoto (JP); JP SCIENTIFIC LIMITED, Waterloo (CA)

(21) Appl. No.: 17/916,499

(22) PCT Filed: Apr. 3, 2021
(86) PCT No.: PCT/JP2021/014418

§ 371 Date: Sep. 30, 2022

Related U.S. Application Data
(60) Provisional application No. 63/004,703, filed on Apr. 3, 2020.

(51) Int. Cl. G01N 1/40; H01J 49/16

(52) U.S. Cl. CPC G01N 1/405; H01J 49/165

(57) ABSTRACT

A method for identifying a target component of interest in a specimen by probe electrospray ionization mass spectrometry, including: (1) adsorbing the target component of interest onto an extraction phase for adsorbing the target component of interest from the specimen by immersing a probe into the specimen, wherein the probe is at least partially coated with the extraction phase; (2) removing the probe from the specimen and optionally quick rising it by dipping in or spraying water or acetone/water mixtures; (3) adhering solvent to the extraction phase; (4) desorbing the target component of interest into the solvent from the extraction phase; (5) electrospraying the target component of interest desorbed in the solvent adhered to the probe on the ionization source at atmospheric pressure by applying a voltage to the probe to spray aerosolized ionized droplets out of the probe; and (6) identifying the target component of interest present in the aerosolized ionized droplets.

### CROSS-REFERENCE TO RELATED APPLICATION

This application claims priority from U.S. provisional application No. 63/004,703, filed Apr. 3, 2020, which is incorporated herein by reference in its entirety.

### TECHNICAL FIELD

Statement Regarding Prior Disclosures by the Inventors

(1) Development and Application of Solid-Phase Microextraction Probe Electrospray Ionization, published Dec. 21, 2020.

(2) Solid-Phase Microextraction-Probe Electrospray Ionization Devices for Screening and Quantitating Drugs of Abuse in Small Amounts of Biofluids, published Mar. 18, 2021.

The present invention relates to a method for analyzing a specimen material by mass spectrometry and a mass spectrometry device used for the method. More specifically, the present invention relates to the method for identifying a target component of interest in a specimen by mass spectrometry with a probe electrospray ionization method and a mass spectrometry device including an ion source employing the probe electrospray ionization method.

### BACKGROUND ART

Various methods have been typically proposed as the technique of ionizing a target component of interest in a specimen in a mass spectrometry device and have been in practical use. For example, an electrospray ionization (ESI) method and a matrix assisted laser desorption/ionization (atmospheric pressure MALDI) method have been known as an ionization method for performing ionization in atmosphere.

Regarding a specimen with a complicated matrix, such as a biological specimen, when a target component of interest in the specimen is ionized without pretreatment, ion suppression or enhancement is caused for signal intensity by the matrix at the time of ionizing the target component. As a result, the existence or concentration of the target component of interest in the specimen cannot be accurately measured.

For this reason, in the case of employing the ESI method as the ionization method, the target component of interest usually separated from the matrix by, for example, liquid chromatography (LC), gas chromatography (GC) or an ICP before mass spectrometry.

In the case of employing the atmospheric pressure MALDI method as the ionization method, it is conventional to perform such pretreatment that improve the efficiency for ionizing the target component of interest, after cooling the specimen such as the biological specimen to a predetermined temperature and drying it, by applying a specific matrix to the surface of the specimen.

As described above, for the ESI method and the atmospheric pressure MALDI method typically used as the ionization method, the step of separating a matrix component (extraction of the target component of interest) or the pretreatment for enhancing the efficiency for ionizing the target component of interest is necessary in order to detect the target component of interest with accuracy and to measuring its concentration and so on. As a result, analysis time becomes longer, and a procedure performed by an analyst is complicated.

Moreover, a highly polar highly polar-compound such as an aminoglycoside-based antibacterial agent or catecholamines has a high boiling point due to intermolecular interaction. For the highly polar highly polar-compound, measurement by the GC-MS is difficult, and measurement by the LC-MS or LC-MS/MS is mainly performed. However, the highly polar highly polar-compound is not dissolved in an organic solvent commonly used as a mobile phase, and it is difficult to hold the highly polar highly polar-compound by reversed phase chromatography. For this reason, in the case of analyzing the highly polar compound, hydrophilic interaction chromatography using an aqueous mobile phase in which the highly polar compound is eluted should be performed. However, for the hydrophilic interaction chromatography, setting of analysis conditions such as column conditioning, equilibration, and mobile phase PH adjustment is complicated, and a burden on an analyst is great.

### SUMMARY OF INVENTION

The present invention has been made for solving the above-described problems. A main object of the present invention is to provide a method for identifying a target component of interest in a specimen such as a highly polar compound, which is hardly measured by LC/MS or GC/MS, with high quantitative accuracy without performing a separation step or a pretreatment process necessary for a typical ionization method such as an ESI method or an atmospheric pressure MALDI method. Moreover, another main object of the present invention is to provide an analysis device configured to implement the analysis method.

That is, the present invention relates to the following method for identifying a target component.

A method for identifying a target component of interest in a specimen by probe electrospray ionization mass spectrometry,

the method comprising:

(1) adsorbing the target component of interest onto an extraction phase for adsorbing the target component of interest from the specimen by immersing a probe into the specimen, wherein the probe is at least partially coated with the extraction phase;

(2) removing the probe from the specimen;

(3) adhering solvent to the extraction phase;

(4) desorbing the target component of the interest into the solvent adhered to the probe from the extraction phase;

(5) electrospraying the target component of interest desorbed in the solvent adhered to the probe on the ionization source at atmospheric pressure by applying a voltage to the probe to spray aerosolized ionized droplets out of the probe; and,

(6) identifying the small molecule component of interest present in the aerosolized ionized droplets.

Further, the present invention relates to the following devices for identifying a target component.

A mass spectrometer for identifying a target component of interest in a specimen,

the mass spectrometer comprising

a conductive probe being at least partially coated with an extraction phase for adsorbing the target component of interest from the specimen,

a container unit which holds solvent inside;

a voltage generation unit which applies a voltage to the probe,

a displacement unit which causes at least one of the probe arranged extending in the vertical direction and the container unit arranged below the probe, to move vertically so as to cause the probe to immerse into the solvent in the container unit and so as to remove the probe from the solvent unit;

wherein, after the solvent is adhered to the probe by the displacement unit and then the extracted target component of interest adsorbed onto the extraction phase is desorbed into the solvent adhered to the probe, extracted target component of interest desorbed in the solvent adhered to the probe are ionized under atmospheric pressure utilizing the electrospray phenomenon by applying a voltage to the probe by means of the voltage generation unit.

A mass spectrometer for identifying a target component of interest in a specimen,

the mass spectrometer comprising:

a conductive probe being at least partially coated with an extraction phase for adsorbing the target component of interest from the specimen,

spraying means to spray solvent onto the probe,

a voltage generation unit which applies a voltage to the probe,

wherein, after the solvent is adhered to the probe by spraying means and then the extracted target component of interest present adsorbed onto the extraction phase is desorbed into the solvent adhered to the probe, extracted target component of interest desorbed in the solvent adhered to the probe are ionized under atmospheric pressure utilizing the electrospray phenomenon by applying a voltage to the probe by means of the voltage generation unit.

According to the method of the present invention, unlike the ESI method and the MALDI method, detection of the target component of interest in the specimen and concentration measurement can be performed without performing a separation step requiring a certain amount of time and pretreatment making a procedure performed by an analyst complicated. As a result, analysis time can be shortened, and a burden on the analyst can be significantly reduced.

Further, by means of selecting a suitable extraction phase, a target component of interest in a specimen, such as a highly polar compound which is hardly measured by the conventional GC/MS or LC/MS, can be extracted with a high concentration and the analysis of the target component of interest can be performed with high quantitative accuracy.

### BRIEF DESCRIPTION OF DRAWINGS

FIG. 1 is a schematic view of a probe used for the method of the present invention, the probe being at least partially coated with an extraction phase.

FIG. 2 is a schematic view when a target component of interest is adhered to the probe at least partially coated with the extraction phase.

FIG. 3 is the comparison results analyzing the blood plasma under identical conditions by using above-described method and the conventional PESI method.

FIG. 4 shows the extraction time profile of drugs of abuse of Example 2.

FIG. 5 shows the results of the experiments of Example 2 using normalized area counts.

FIG. 6 illustrates the difference between the electrospray patterns of SPME-PESI-MS/MS and PESI-MS/MS of Example 2.

FIG. 7 shows an extraction time profile of drugs of abuse from small volume plasma samples by LC-MS/MS of Example 2.

FIG. 8 shows the calibration curves for the eight drugs of abuse of Example 2.

FIG. 9 shows ETPs for PBS and plasma constructed from the LC-MS/MS experiments of Example 2.

FIG. 10 shows a calibration curve constructed by SPME-PESI-MS/MS by extracting spiked PBS with diazepam.

FIG. 11 shows aminoglycosides used in Example 4.

FIG. 12 shows the effect of varying sample pH in Example 4.

FIG. 13 shows the results of a matrix modification investigation of Example 4.

FIG. 14 shows an extended Matrix Modification of Water to Enhance Amino-glycoside Extraction of Example 4.

FIG. 15 shows the results for optimal desorption solvent in Example 4.

FIG. 16 shows the results of an investigation conducted to check whether the aminoglycosides would remain onto a coating after a rinsing step in Example 4.

FIG. 17 shows the calibration curve of drugs of abuse using SPME-PESI-MS/MS in Example 5.

FIG. 18 shows the calibration curves for eight drugs of abuse in Example 5.

### DESCRIPTION OF EMBODIMENTS

The method of the exemplary embodiments of the present invention is the method for identifying a target component of interest by a PESI method to which the solid phase micro extraction (SPME) technique of extracting the target component of interest in a specimen is applied. More specifically, the method of the present invention is the method for performing analysis with a probe for the PESI method being coated with extraction phase polymer.

The specimen containing the target component of interest includes, but not limited to, living specimens such as urine, blood, and pieces of tissue, food such as vegetables and fruits, and various industrial products, for example. Moreover, the target component of interest includes pathogens such as bacteria and viruses contained in pieces of tissue, nutrition and remaining agricultural chemical components contained in food, and various additives and volatile substances contained in industrial products. The target component of interest is not specifically limited as long as the target component of interest is a substance to be ionized by the PESI method.

In a conventional ESI method or a conventional atmospheric pressure MALDI method, it is difficult to reduce the beam diameter of laser light to equal to or less than several dozen tens of &micro;m due to fundamental limitations. Moreover, a spatial resolution of 50 &micro;m is a limit because ablation across spread a wide area. Therefore, it is extremely difficult to obtain a resolution of equal to or less than 1 &micro;m. A probe electrospray ionization (PESI) method as an ionization method utilizing the ESI described above has been recently developed as the method for improving the resolution (e.g., WO 2010/047399, JP-A-2014-44110, Japanese Patent No. 4862167).

As described in WO 2010/047399 above, in this method, a probe tip end catch a specimen by making the tip end of a conductive probe contact with the specimen containing a target component of interest, and a high voltage for implementing electrospray is applied to the probe with supplying a solvent to the probe tip end after catching the specimen, resulting in ionizing molecules in the specimen on the probe tip end. This method has recently attracted attention.

The identifying method of the exemplary embodiments of the present invention includes a step of adsorbing the target component of interest onto an extraction phase for adsorbing the target component of interest from the specimen by immersing a probe into the specimen, the probe being at least partially coated with the extraction phase (hereinafter may be referred to as “Step (1)”).

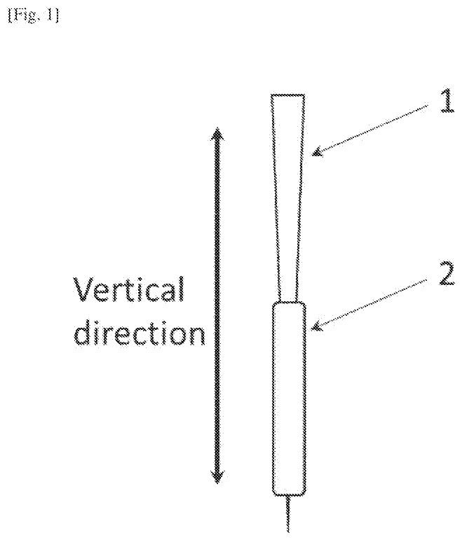

A probe 1 to be immersed in a specimen is, as illustrated in FIG. 1, for example, at least partially coated with an extraction phase 2. A portion of 1 to 4 mm from a tip end of the probe may be coated, and more preferably, a portion of about 2 mm from the tip end of the probe may be coated. Moreover, the thickness of the extraction phase as a coating may be within a range of 2 to 50 &micro;m, more preferably a range of about 3 to 10 &micro;m, and much more preferably about 6.5 &micro;m.

Extraction phase polymer for coating the above-described probe, for example, includes polyacrylonitrile, poly pyrrole, poly (dimethylsiloxane), polyacrylate, poly (ethylene glycol), poly (divinylbenzene), polypyrrole, fluorocarbon, carbon nanotube, graphitic carbon nitride, boron nitride, metal organic frameworks, and porous aromatic frameworks. These polymers may be or may not be substituted according to the intended use. Of these polymers, substituted or unsubstituted poly(divinylbenzene) is more preferable. But the extraction phase polymer is not limited to this, is designed to prevent adsorption of macromolecules onto the extraction phase as matrix compatible coating binders for adsorptive particles. And the extraction phase polymer may be designed based on the resistance for the solvent being adhered to the probe. And the extraction phase is not limited to the polymer, may be fluorocarbon, carbon nanotubes, graphitic carbon nitride, boron nitride, metal organic frameworks, and porous aromatic frameworks.

Alternatively, the extraction phase polymer may be a mixture of polymer and particles used for solid phase micro extraction (hereinafter sometimes referred to as “SPME”). In the case of using the SPME, a particle size is preferably equal to or less than 5 &micro;m, more preferably a range of 0.5 &micro;m to 3 &micro;m, and much more preferably 1 &micro;m, considering electrospraying described later. The particles used for SPME is not limited to this, and the extraction phase can include a polymer that adsorbs the target molecule, or a polymer having solid pores and solid phase microextraction (SPME) particles that are sized not to adsorb non-target components. The example of no-target components are large molecular weight components which has bigger particle size than the target components.

A dry temperature of the extraction phase polymer is, depending on the extraction phase polymer to be used, such a temperature that the extraction phase polymer to be used is sufficiently solidified, and is from 80° C. to 100° C., for example. Moreover, dry time may be also such time that the extraction phase polymer to be used is sufficiently solidified, and is 10 seconds to 30 seconds, for example.

The step of immersing a probe tip end region in a suspension containing the extraction phase polymer, the step of removing the probe from the suspension, and the step of drying the extraction phase polymer adhered to the probe are repeated in this order until the thickness of the extraction phase coating the probe reaches a desired thickness. In this manner, the probe coated with the extraction phase having the desired thickness can be produced. The thickness of the extraction phase is as described above.

The above-described extraction phase may further contain a bioaffinity agent that is a selective cavity. A bioaffinity agent is preferably selected from the group consisting of a selective cavity, a molecular recognition moiety, a molecularly imprinted polymer and an immobilized antibody.

The probe produced by the above-described method and coated with the extraction phase is immersed in the specimen, and in this manner, a target component of interest in the specimen can be adsorbed onto the extraction phase.

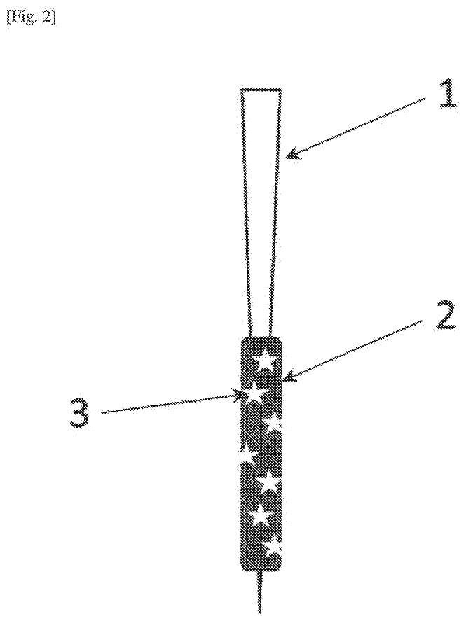

Next, by a step of removing the probe from the specimen (hereinafter may be referred to as “Step (2)”), the probe is pulled out of the specimen, and a target component 3 of interest is adsorbed onto the extraction phase as illustrated in FIG. 2.

Subsequently, by a step of adhering solvent to the extraction phase (hereinafter may be referred to as “Step (3)”). the solvent is adhered to the extraction phase on the probe. One of ways of introducing the solvent onto the probe and/or extraction phase is to immerse the probe into the solvent and to remove the probe from the solvent. The alternative way of introducing the solvent onto the probe and/or extraction phase is to spraying solvent onto the probe and/or extraction phase. Desorption of the analytes onto the solvent might occur when the probe is immersed in solvent, especially for polar compound, so the probe and/or extraction phase can avoid immersing into the solvent and desorption of the analytes onto the solvent by spraying the solvent onto the probe and/or extraction phase.

By a step of desorbing the target component of interest into the solvent from the extraction phase (hereinafter may be referred to as “Step (4)”), the solvent adhered to the probe by Steps (3) above extracts the target component of interest adsorbed onto the extraction phase. By this step, the target component of interest adhered to the extraction phase moves to the solvent adhered to the probe.

Step (4) above is not necessarily after Step (3), and may be at the same time as Step (3). As necessary, Step (3) may be repeated. In the case of repeating Step (3), Step (4) may occur at the same time as initial Step (3), in the middle of repetition, or after the end of repetition of Step (3).

The solvent used at Step (3) above is selected according to the target component of interest. Normally, the examples of solvent are water or an organic solvent such as alkane with a carbon number of about 5 to 8, alcohol with a carbon number of about 1 to 8, ether with a carbon number of about 4 to 10, ketone with a carbon number of about 3 to 10, carboxylic acid with a carbon number of about 2 to 6, and ester with a carbon number of about 3 to 8, and aromatic compounds including toluene and xylene. For example, the organic solvent includes acetonitrile, ethanol, methanol, propanol, and isopropanol. In the case of acid, the organic solvent includes formic acid and acetic acid, for example. However, the organic solvent is not limited to these substances. The organic solvent may be an organic solvent used as a mobile phase in a typical LC/MS or acid added to such a mobile phase.

The organic solvent may contain water, and for example, includes an organic solvent containing a water of 30 to 70% by mass.

In view of handling, preferable solvents among above are water, alkane with a carbon number of about 5 to 8, alcohol with a carbon number of about 1 to 8, ether with a carbon number of about 4 to 10, or carboxylic acid with a carbon number of about 2 to 6, and alcohol with a carbon number of about 2 to 6 or carboxylic acid with a carbon number of about 2 to 4 is more preferable solvent. In view of volatility, ethanol, propanol, or isopropanol is much more preferable.

For the target component of interest adhered to the extraction phase moved into the solvent adhered to the probe by Step (4) above, electrospraying the target component of interest desorbed in the solvent adhered to the probe on the ionization source at atmospheric pressure by applying a voltage to the probe to spray aerosolized ionized droplets out of the probe (hereinafter may be referred to as “Step (5)”) is performed. Liquid droplets containing the target component of interest ionized by Step (5) is identified (hereinafter may be referred to as “Step (6)”). The liquid droplets containing the ionized target component of interest is, for example, identified by a mass spectrometry device. Identifying may include only qualifying or both of qualifying and quantifying.

The above-described probe may be, after Step (5) above, immersed in the above-described solvent again, and Step (5) may be performed. That is, after electrospraying the target component of interest desorbed in the solvent adhered to the probe has been performed once by Step (5), the probe is immersed in the solvent such that the target component of interest still remaining in the extraction phase on the probe is eluted into the solvent, and Step (5) is performed again. In this manner, identifying at Step (6) can be efficiently performed with favorable accuracy.

In addition to Steps (1) to (6) above, the analysis method and/or the probe of the exemplary embodiments of the present invention may include, after Step (1), the step of rinsing includes rinsing the extraction phase and/or the probe with at least one selected from the group consisting of aqueous, organic solvent and mixture thereof (hereinafter may be referred to as a “rinsing step”), in view of rinsing any impurities or a foreign substance other than the target component of interest contained in the specimen in order to improve analysis accuracy. An aqueous and an organic solvent used for the rinsing step are the same as the above-described solvent. And the step of rinsing includes rinsing the probe in aqueous to remove large molecular weight interferences attached onto the surface of the probe. Acetone-water mixture may be used in case of fatty matrices and the sample which contains a lot of fat (ex. milk, avocado). And the step of rinsing includes rinsing the extraction phase and/or the probe via spray. The step of rinsing including, but not limited to, the above method, and the way of rinsing and rinsing time (usually less than a second) may be optimized in consideration of removing interferences and of not desorbing the analytes from the probe and/or the extraction phase.

The analysis method of the exemplary embodiments of the present invention includes Steps (1) to (6) above. Normally, Steps (1) to (6) are performed in this order. However, considering the amount of target component of interest in the specimen, Steps (1) to (6) may be repeated while an analysis result is being monitored. In the case of repeating Steps (1) to (6), the analysis result is accumulated so that the analysis accuracy can be improved, and accurate analysis can be performed with a smaller amount of specimen.

The identifying method of the exemplary embodiments of the present invention is implemented by the following device.

A mass spectrometer for identifying a target component of interest in a specimen,

the mass spectrometer comprising

a conductive probe being at least partially coated with an extraction phase for adsorbing the target component of interest from the specimen,

a container unit which holds solvent inside;

a voltage generation unit which applies a voltage to the probe,

a displacement unit which causes at least one of the probes arranged extending in the vertical direction and the container unit arranged below the probe, to move vertically so as to cause the probe to immerse into the solvent in the container unit and so as to remove the probe from the solvent unit;

wherein, after the solvent is adhered to the probe by the displacement unit and then the extracted target component of interest present adsorbed onto the extraction phase is desorbed into the solvent adhered to the probe, extracted target component of interest desorbed in the solvent adhered to the probe are ionized under atmospheric pressure utilizing the electrospray phenomenon by applying a voltage to the probe by means of the voltage generation unit.

The above device implements one of the preferable embodiments of the identifying method of the exemplary embodiments of the present invention wherein the introduction of the solvent onto the probe and/or extraction phase is performed by immersing the probe into the solvent and to remove the probe from the solvent in step (3).

The identifying method of the exemplary embodiments of the present invention is also implemented by the following device.

A mass spectrometer for identifying a target component of interest in a specimen, the mass spectrometer comprising:

a conductive probe being at least partially coated with an extraction phase for adsorbing the target component of interest from the specimen,

injector configured to provide misty solvent onto the prove,

a voltage generation unit which applies a voltage to the probe,

wherein, after the solvent is adhered to the probe by injector configured to provide misty solvent onto the prove and then the extracted target component of interest present adsorbed onto the extraction phase is desorbed into the solvent adhered to the probe, extracted target component of interest desorbed in the solvent adhered to the probe are ionized under atmospheric pressure utilizing the electrospray phenomenon by applying a voltage to the probe by means of the voltage generation unit.

The above device implements the other preferable embodiments of the identifying method of the present invention wherein the introduction of the solvent onto the probe and/or extraction phase is performed by spraying the solvent onto the probe in step (3).

As described above, the conductive probe is the probe partially coated with the extraction phase, and extracts the target component of interest in the specimen. The extraction phase is as described above, and the production method is also as described above.

The container unit holds the above-described solvent inside, and the probe is inserted into the container unit for the purpose of adsorbing the solvent onto the probe in order to perform one of ways of introducing the solvent onto the probe and/or extraction phase as described above.

The voltage generation unit is a device configured to apply a voltage to the probe, and performs electrospraying at Step (5) above. By the voltage generation unit, the liquid droplets containing the target component of interest are ionized.

The displacement unit is used when the solvent is adsorbed onto the probe in order to perform introducing the solvent onto the probe and/or extraction phase as described above, and the target component of interest adsorbed onto the extraction phase is extracted into the solvent. The displacement unit moves at least one of the probe arranged extending in the vertical direction (the direction of an arrow in FIG. 1) or the container unit arranged below the probe in the vertical direction. The displacement unit may move both of the probe and the container unit. By moving at least one of the probe or the container unit, the probe can be immersed in the solvent in the container, and the probe can be pulled out of the solvent in the container.

On the other hand, injector configured to provide misty solvent onto the prove performs the introduction of the solvent onto the probe and/or extraction phase in step (3).

With the above-described configuration, the voltage generation unit applies under atmospheric pressure a voltage to the target component of interest extracted into the solvent adhered to the probe through Step (3) above, and the target component of interest is ionized by electrospray phenomenon. The ionized liquid droplets are identified by the mass spectrometry device. The mass spectrometry device to be used may be of a tandem type.

Using the mass spectrometry device having the above-described configuration, detection of the target component of interest in the specimen and concentration measurement can be, differently from the ESI method and the MALDI method, suitably performed without the need for performing a separation step requiring a certain amount of time and pretreatment requiring a procedure complicated to an analyst. Further, for a target component of interest in a specimen, such as a highly polar compound of which measurement is difficult to be performed by typical GC/MS or LC/MS, analysis can be also performed with high quantitative accuracy.

### EXAMPLES

Next, the exemplary embodiments of the present invention will be described in detail with reference to examples, but the scope of the present invention is not limited by such examples.

### Example 1

<Probe Coating Method>

The method for adjusting slurry used upon coating of the probe is as follows.

A 7% (weight/volume) mixture of polyacrylonitrile (PAN) in dimethylformamide (DMF) was prepared which will be referred to as the coating binder. A slurry with a composition of 9.2% Hydrophilic-lipophilic balance particles (HLB) particles (particle size: 1 &micro;m), 87.9% of coating binder (PAN), and 2.8% glycerol was subsequently prepared. The negatively charged polyacrylonitrile minimizes the binding of macromolecules (i.e., proteins) and allows for selective permeation of target components which are small molecules to the extraction phase.

The HLB particles used for the above-described slurry was adjusted by the following method.

HLB particles were prepared using divinylbenzene and N-vinylpyrrolidone monomers. The quantity of functional group present in the final particles were determined by elemental analysis and found to have from 20 to 25% of N-vinylpyrrolidone which has ketone groups having surface area in the range of 200-700 m² per gram depending upon synthesis method and intended applications. For PESI application, we are using HLB particles having surface area of 200 m² per gram, 20% N-vinylpyrrolidone. The method for forming the HLB particles with a desired particle size includes, but not limited to, membrane separation, centrifugal separation, and ultrasonic separation, for example.

Moreover, for the probe, etching was performed as follows at the previous step of coating the probe with the slurry adjusted by the above-described method. PESI probes were submerged in diluted HCl (7.4%) and placed on a water bath sonicator for 15 min. The probes were then submerged in water and placed on a water bath sonicator for 20 min. The probes were subsequently submerged in MeOH on a water bath sonicator for 20 min. Immediately after the probes were dried via heat.

Specific steps when the etched probe is coated with the adjusted slurry are as follows.

1) Position the PESI probe such that the tip of the probe ever so slightly touched the surface of the coating slurry. The adjustment of the PESI probe's position to slightly touched the surface of the coating slurry was done by using the dip coater motor (Thorlabs,Inc. (MTS50/M-Z8E, 50 mm)). It was confirmed by using two electrodes attached a sensor which generated a noise once a circuit between the two electrodes was completed whether the tip of the probe slightly touched the surface of the coating slurry. The electrodes were alligator clips; one clip was attached to the PESI probe and the other clip was attached to a therapeutic needle that was dipped into the slurry.

2) The PESI probe was dipped either 1, 2, or 4 mm into the coating slurry with the following parameters: velocity=2.4 mm/s, acceleration=1.5 mm/s², jog step=0.5 mm.

3) When once the probe descended to the specified distance mentioned above, the probe immediately ascended until it was 18 mm above the coating slurry. The parameters used for the ascension of the PESI probe were the same as for the dipping of the PESI probe.

4) Immediately after the ascension of the PESI probe out of the coating slurry, the coated probe was placed in a 90&#730;C. oven for 20 s.

5) Steps 2 to 4 were repeated until desired coating thickness (in this case, the coated portion of the probe had a diameter of roughly 150 &micro;m (coating thickness &#8776; 6.5 &micro;m))was met (usually a desired coating thickness and the number of coatings required to achieve the coating thickness are constant).

Next, an example of the steps of the analysis method by the present development will be described.

<Analysis Conditions>

1. Type of Specimen

Specimen Type: Blood Plasma (drugs of abuse (Hereafter referred to as DoA))

Target Component: Buprenorphine, Codeine, Diazepam, Fentanyl, Lorazepam, Nordiazepam, Oxazepam, and Propranolol

2. Analysis Steps and Parameters

1. Step of Adsorbing Sample onto Extraction Phase Polymer (Step (1))

Sample: 30 uL, Set to 18° C.±2° C.

Adsorption Time: 60 minutes

2. Step of Adhering Solvent to Probe (Steps (2) and (3))

Solvent Configuration: Isopropanol and Water (a ratio of 1:1) and 0.1% formic acid

The Number of Times of Adherence of Probe to Solvent: 73

Probe Stop Position (Distance from Initial Probe Stop Position): −44 mm

Solvent Position (Distance from Initial Probe Stop Position): −46 mm

Time for Adhering Sample to Extraction Phase: 50 ms

Probe Drive Speed: 250 mm/s

Probe Drive Acceleration: 1 G

Cycle: 12.04 Hz

3. Step of Applying Voltage to Probe (Step (6))

Magnitude of Voltage to be Applied to Probe: 2.3 kV

The Number of Times of Repetitions of Ionization: 73

Ionization Time (Time for Applying Voltage to Probe): 200 ms

Ionization Position (Distance from Initial Probe Stop Position): −37 mm

Solvent Position (Distance from Initial Probe Stop Position): −46 mm

Probe Drive Speed: 250 mm/s

Probe Drive Acceleration: 0.63 G

Cycle: 2.48 Hz

4. Mass Spectrometry

Mass Spectrometer: Tandem Mass Spectrometer

Quantitative Determination Method: Multiple Reaction Monitoring (MRM)

MRM Parameters

Table 1: Mass Spectrometer Parameters

Table 2: Other Mass Spectrometry Parameters

TABLE 1

| | Precursor | Product Ion | Pause Time | Dwell Time | Q1 Pre | Collision | Q3 Pre Bias |
|---|---|---|---|---|---|---|---|
| Compound | Ion (m/z) | (m/z) | (msec) | (msec) | Bias (V) | Energy | (V) |
| Codeine | 300.15 | 165.15 | 1 | 1 | −11 | −42 | −11 |
| Codeine | 300.15 | 215.15 | 1 | 1 | −11 | −24 | −15 |
| Codeine-d3 | 303.15 | 215.1 | 1 | 1 | −11 | −26 | −15 |
| Lorazepam | 321 | 275.1 | 1 | 1 | −12 | −21 | −20 |
| Lorazepam | 321 | 229.1 | 1 | 1 | −12 | −29 | −24 |
| Lorazepam-d4 | 325.15 | 279 | 1 | 1 | −10 | −24 | −19 |
| Oxazepam | 286.9 | 241.1 | 1 | 1 | −11 | −24 | −16 |
| Oxazepam | 286.9 | 269.1 | 1 | 1 | −14 | −16 | −19 |
| Nordiazepam | 271 | 140.1 | 1 | 1 | −10 | −26 | −25 |
| Nordiazepam | 271 | 165.1 | 1 | 1 | −10 | −27 | −17 |
| Nordiazepam-d5 | 276.2 | 213.15 | 1 | 1 | −11 | −27 | −15 |
| Diazepam | 285 | 193.1 | 1 | 1 | −11 | −30 | −13 |
| Diazepam | 285 | 154.1 | 1 | 1 | −11 | −27 | −16 |
| Diazepam-d5 | 290.25 | 198.1 | 1 | 1 | −11 | −32 | −21 |
| Propranolol | 260.35 | 116.15 | 1 | 1 | −10 | −15 | −10 |
| Propranolol | 260.35 | 183.1 | 1 | 1 | −10 | −17 | −22 |
| Propranolol-d7 | 267.15 | 116.2 | 1 | 1 | −10 | −19 | −12 |
| Buprenorphine | 468.25 | 55.1 | 1 | 1 | −11 | −50 | −21 |
| Buprenorphine | 468.25 | 396.25 | 1 | 1 | −11 | −39 | −30 |
| Buprenorphine-d4 | 472.25 | 59.2 | 1 | 1 | −11 | −52 | −22 |
| Fentanyl | 337.15 | 188.25 | 1 | 1 | −10 | −24 | −13 |
| Fentanyl | 337.15 | 105.1 | 1 | 1 | −10 | −38 | −19 |
| Fentanyl-d5 | 342.25 | 188.2 | 1 | 1 | −13 | −24 | −13 |

TABLE 2
Other Mass Spectrometry Parameters
Mass Spectrometer Parameters
Interface Voltage: 2.3 kV
DL Temperature: 250° C.
Heating Block: 30° C.
CID Gas: 270 kPA

Analysis was performed at the following steps, for example.

1. Specimen materials which concentrations of blood plasma were 1, 5, 10, 25, 50, 75, and 100 ng/mL were added into sample containers.

2. An internal standard of 10 ng/mL was further added to each of these sample containers.

3. The Specimen materials in these sample containers were stored for one day in a refrigerator at 4° C., and blood plasma protein was bound accordingly.

4. The Specimen materials in these sample containers were taken out of the refrigerator, and temperature adjustment to a room temperature was performed.

5. After having been rinsed with rinsing fluid (methanol (hereinafter referred to as “MeOH”)/acetonitrile (hereinafter referred to as “ACN”/isopropanol (hereinafter referred to as “IPA”)=2/1/1 in terms of a volume ratio) for 15 minutes, the probe coated by the above-described method was incubated with a conditioning solution (MeOH/H₂O=1/1 in terms of a volume ratio) for 15 minutes.

6. The probe was inserted into each sample container and was left to stand at the room temperature for one hour, and in this manner, the Specimen materials was adsorbed onto the extraction phase (the HLB particles) coating the probe.

7. The probe including an extraction phase region was rinsed with H₂O for about three seconds.

8. The solvent to which 10 &micro;L of IPA/H₂O=1/1 (in terms of a volume ratio)+0.1% by mass of formic acid had been added was housed in the container, and was arranged at the solvent position of the mass spectrometer. Thereafter, the probe was moved from the probe stop position to the solvent position, and the solvent was adhered to the probe. After a lapse of 50 ms, the probe was moved to the probe stop position. Such processing was repeated 73 times, and in this manner, a desired amount of solvent was adhered to the probe.

9. After each Specimen material adhered to the extraction phase had been desorbed from the solvent adhered to the probe, a voltage of 2.3 kv was applied to the probe for 200 ms, and each Specimen material eluted into the solvent was ionized. Thereafter, the probe was moved to the solvent position, and the solvent was adhered to the probe. Then, the probe was moved to the ionization position again, and a voltage was applied. In this manner, each blood plasma sample was ionized. Such processing was repeated 73 times.

10. By the mass spectrometer, the mass spectrometry was performed at a cycle of 2.48 Hz by means of the parameters described in Table 1 and Table 2 above.

<Analysis Result>

A blood plasma of 30 &micro;L to which the specimen material had been added such that a concentration falls within a range of 1 to 100 ng/mL was extracted, and in this manner, a corrected standard curve was produced. The determination limits (LLOQ) of fentanyl and nordiazepam were 1 ng/mL. The LLOQs of buprenorphine, codeine, lorazepam, diazepam, and propranolol were 5 ng/mL, and the LLOQ of oxazepam was 10 ng/mL.

In all compounds other than a QC-level lorazepam of 30 ng/mL, intraday accuracy was within a range of 80 to 120%. The intraday accuracy of a QC-level lorazepam of 30 ng/mL was 122%.

Moreover, the intraday precisions of all compounds were lower than 15%, and the daily precisions of all compounds other than a QC-level lorazepam (16%) of 30 ng/mL and a QC-level oxazepam (27%) of 90 ng/mL were lower than 15%.

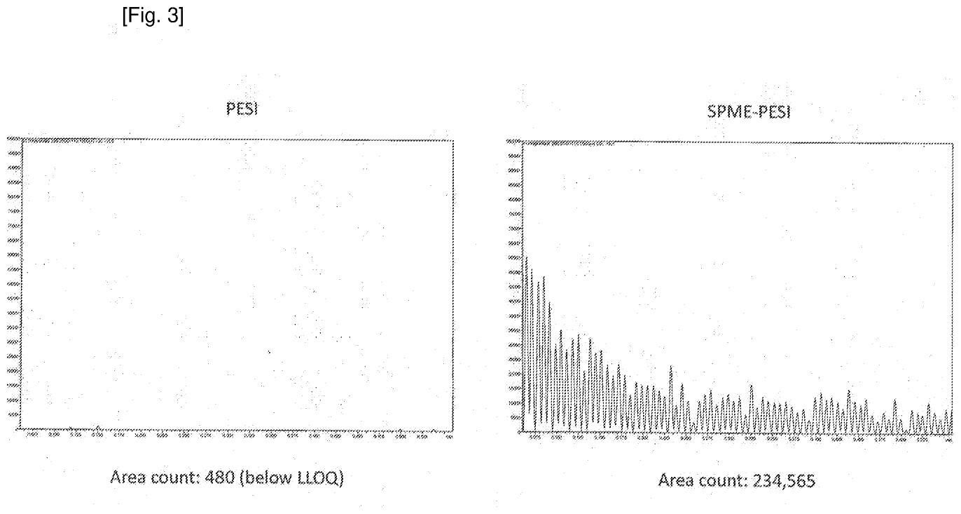

FIG. 3 was the comparison results analyzing the blood plasma under identical conditions by using above-described method and the conventional PESI method.

The conventional PESI method was was performed at the following steps,

1. Add 270 uL of MeOH into 30 uL of plasma, and then vortex.

2. Centrifuge at 14,000 rpm, for 10 min by using tabletop centrifuge.

3. Take supernatant and dilute with water and formic acid to become 50% MeOH and 0.1% formic acid.

4. Probes were placed into the DPiMS-8060 source, then 10 μL of sample was placed in the sample plate.

The peak area account of the analyte in the above-described method is about five hundred times more than the conventional PESI method. From this, it can be inferred that the above-described method further increases the measurement sensitivity than the conventional PESI method.

By the above-described method, e.g., detection of the target component of interest in the specimen and concentration measurement are performed without the need for performing the separation step requiring the certain amount of time or the pretreatment requiring the process complicated for the analyst. As a result, analysis time can be shortened, and a burden on the analyst can be significantly improved.

Further, for the target component of interest in the specimen, such as the highly polar compound, suitable extraction phase polymer is selected so that analysis can be performed with high quantitative accuracy.

Moreover, the probe coated with the extraction phase is produced and is used for the PESI as described above, and therefore, the above-described method can be suitably implemented.

### Example 2

Example 2 involves the application of SPME-PESI-MS/MS using commercially available PESI probes coated with polymeric material and a DPiMS-8060 interface. The development of the probe was tested using drugs of abuse in phosphate buffered saline (PBS) and then for detecting the drugs of abuse in small volumes of plasma was developed.

LC-MS grade acetonitrile (ACN), isopropanol (IPA), methanol (MeOH), and water (H₂O) were used. FA, sodium chloride, potassium chloride, potassium phosphate monobasic, sodium phosphate dibasic, hydrochloric acid, HPLC grade MeOH were purchased from Sigma Aldrich (Oakville, ON, Canada). The following chemicals were purchased from Sigma Aldrich (Oakville, ON, Canada) specifically for the synthesis of 1.3 &micro;m HLB particles; divinylbenzene, N-vinylpyrrolidone, and 2,2-Azobis (isobutyronitrile). The analytical standards and their deuterated analogues were purchased from Cerilliant Corporation (Round Rock, Tex., USA): buprenorphine, codeine, diazepam, fentanyl, lorazepam, nordiazepam, oxazepam, propranolol, buprenorphine-d₄, codeine-d₃, diazepam-d₅, fentanyl-d₅, lorazepam-d₄, nordiazepam-d₅, and propranolol-d₇. The deuterated analogue of the standards was used for IS correction when applicable. The exception was for oxazepam where nordiazepam-d5 was used as the internal standard when applicable. Frozen, pooled gender, non- filtered human plasma with K₂EDTA as the anticoagulating agent was purchased from Bioreclamation IVT (Westbury, N.Y., USA).

Methanolic working standards were prepared from the master standards of analytes listed in Table 2.1 below with concentrations such that only a maximum of 1% organic working standard was spiked into samples of PBS or plasma. This was to prevent alterations to the matrix that can measurably affect either the equilibrium constant between the coated probe and the sample.

An in-house built stage equipped with a motor (MTS50/M-Z8E, 50 mm) from ThorLabs Inc. (Newton, Mass., USA) was used for dip coating the PESI probes.

LC-MS/MS experiments were conducted on a Shimadzu LCMS 8060 triple quadrupole mass spectrometer with Shimadzu LC-30AD liquid chromatography system. Detailed information on the selected reaction monitoring transitions used to quantify analytes for the LC-MS/MS experiments can be found in Table 2.1. Further experimental conditions about the LC-MS/MS method can be found in Table 2.2 and Table 2.3. The autosampler was thermostated to 4&#730;C and used for injection of 3 &micro;L or 6 &micro;L of PBS or plasma extracted samples, respectively. A Phenomenex Kinetex PFP column (2.1×100 mm×1.7 &micro;m particle size) was purchased directly from Phenomenex (Torrance, Calif., USA) was used for separation. The column oven was thermostated to 35&#730;C and the flow rate used was 300 &micro;L/min. Mobile phase A was water while mobile phase B was MeOH/ACN (v/v, 7/3) and both mobile phases contained 0.1% formic acid. The gradient was run at 10% B for 1.0 min, linearly ramped to 100% B until 7.0 min, and held at 100% B until 9.0 min. The column returned to 10% B at 9.2 min and allowed to re-equilibrate until 11.0 min.

TABLE 2.1
Multiple Reaction Monitoring Parameters for Drugs of Abuse

| | | | | Precursor | Product | Q1 Pre- | Collision | Q3 Pre- |
|---|---|---|---|---|---|---|---|---|
| # | Compound | Internal Standard | LogP | Ion (m/z) | Ion (m/z) | Bias (V) | Energy | Bias (V) |
| 1 | Buprenorphine | Buprenorphine-d₄ | 4.98^{a} | 468.3 | 55.1 | −11 | −50 | −21 |
| 1 | Buprenorphine | Buprenorphine-d₄ | 4.98^{a} | 468.3 | 396.3 | −11 | −39 | −30 |
| 2 | Buprenorphine-d₄ | | | 472.3 | 59.2 | −11 | −52 | −22 |
| 3 | Codeine | Codeine-d₃ | 1.39^{a} | 300.2 | 165.2 | −11 | −42 | −11 |
| 3 | Codeine | Codeine-d₃ | 1.39 ^{a} | 300.2 | 215.2 | −11 | −24 | −15 |
| 4 | Codeine-d₃ | | | 303.2 | 215.1 | −11 | −26 | −15 |
| 5 | Diazepam | Diazepam-d₅ | 2.82 ^{a} | 285.0 | 193.1 | −11 | −30 | −13 |
| 5 | Diazepam | Diazepam-d₅ | 2.82 ^{a} | 285.0 | 154.1 | −11 | −27 | −16 |
| 6 | Diazepam-d₅ | | | 290.3 | 198.1 | −11 | −32 | −21 |
| 7 | Fentanyl | Fentanyl-d₅ | 4.05 ^{a} | 337.2 | 188.3 | −10 | −24 | −13 |
| 7 | Fentanyl | Fentanyl-d₅ | 4.05 ^{a} | 337.2 | 105.1 | −10 | −38 | −20 |
| 8 | Fentanyl-d₅ | | | 342.3 | 188.2 | −13 | −24 | −13 |
| 9 | Lorazepam | Lorazepam-d₄ | 2.39 ^{a} | 321.0 | 275.1 | −12 | −21 | −20 |
| 9 | Lorazepam | Lorazepam-d₄ | 2.39 ^{a} | 321.0 | 229.1 | −12 | −29 | −24 |
| 10 | Lorazepam-d₆ | | | 325.2 | 279.0 | −10 | −24 | −19 |
| 11 | Nordiazepam | Nordiazepam-d₅ | 2.79 ^{a} | 271.0 | 140.1 | −10 | −26 | −25 |
| 11 | Nordiazepam | Nordiazepam-d₅ | 2.79 ^{a} | 271.0 | 165.1 | −10 | −27 | −17 |
| 12 | Nordiazepam-d₅ | | | 276.2 | 213.2 | −11 | −27 | −15- |
| 13 | Oxszapam | Nordiazepam-d₅ | 2.24 ^{a} | 286.9 | 241.1 | −11 | −24 | −16 |
| 13 | Oxazepam | Nordiazepam-d₅ | 2.24 ^{a} | 286.9 | 269.1 | −14 | −16 | −19 |
| 14 | Propranolol | Propranolol-d₇ | 3.48 ^{a} | 260.4 | 116.2 | −10 | −17 | −22 |
| 14 | Propranolol | Propranolol-d₇ | 3.48 ^{a} | 260.4 | 183.1 | −10 | −18 | −12 |
| 15 | Propranolol-d₇ | | | 267.2 | 116.2 | −10 | −19 | −12 |

^{a}LogP values retrieved from Drug bank, accessed in April 2020
Note
that product ions bolded are the quantitave ions Pause time and dwell time for all compounds were both 1 msec

TABLE 2.2
MS conditions for LC-MS/MS
MS parameters on the LCMS-8060

| | |
|---|---|
| Ionization Mode | ESI |
| Interface voltage | 4.0 kV (positive) |
| Interface temperature | 300° C. |
| Desolvation line temperature | 250° C. |
| Heating block temperature | 400° C. |
| Nebulizing gas flow | 3.0 L/min |
| Drying gas flow | 10.0 L/min |
| Heating gas flow | 10.0 L/min |
| Collision gas and pressure | Argon, 270 kPa |
| Dwell Time | 10 ms |

TABLE 2.3
LC Conditions

| | Optimized LC conditions | | |
|---|---|---|---|
| Column | Phenomenex Kinetex PFP Column | | |
| | 2.1 × 100 mm, 1.7 μm particle size, 100Å Torrance, CA, USA | | |
| Mobile phase | A: water with 0.1% formic acid | | |
| | B: methanol/acetonitrile (v/v 7/3) with 0.1% formic acid | | |
| Flow rate | 300 μL min⁻¹ | | |
| Column | 35° C. | | |
| temperature | | | |
| Autosampler | 4° C. | | |
| temperature | | | |
| Sample | 3 μL for PBS extracts | | |
| injection | 6 μL for PBS extracts | | |
| volume | | | |
| | Time (min) | % A | % B |
| Gradient | 0.0 | 90 | 10 |
| | 1.0 | 90 | 10 |
| | 7.0 | 0 | 100 |
| | 9.0 | 0 | 100 |
| | 9.2 | 90 | 10 |
| | 11.0 | 90 | 10 |

SPME-PESI-MS/MS experiments were conducted using a Shimadzu DPiMS-8060 interface (Kyoto, Japan) and a Shimadzu LCMS 8060 (Kyoto, Japan) triple quadrupole mass spectrometer. Extensive instrumental details and optimized DPiMS-8060 interface and MS/MS parameters are provided in Tables 2.1, Table 2.4, and Table 2.5. The outage time in the sample position was 50 ms, and the outage time in the ionization position was 200 ms. An interface voltage of 2.3 kV was applied when the probe was at the ionization position. The total acquisition time per sample was set to 0.56 min.

TABLE 2.4
DPiMS-8060 Parameters for PESI-MS/MS

| | MS parameters on the LCMS-8060 | | |
|---|---|---|---|
| Extraction Mode | Top Position | −44.00 | mm |
| | Bottom Position | −46.00 | mm |
| | Count | 1 | |
| | Probe Speed | 250.00 | mm/s |
| | Probe Acceleration | 1.00 | G |
| Analysis Mode | Ionization Position | −37.00 | mm |
| | Outage time (Ionization Position) | 200 | ms |
| | Sample Position | −46.00 | mm |
| | Outage time (Sample Position) | 50 | ms |
| | Probe Speed | 250 | mm/s |
| | Probe Acceleration | 0.63 | G |

TABLE 2.5
Optimized MS conditions for SPME-PESI-MS/MS
MS parameters on the LCMS 8060

| | |
|---|---|
| Ionization Mode | ESI |
| Interface voltage | 2.3 kV (positive) |
| Desolvation line temperature | 250° C. |
| Heating block temperature | 30° C. |
| Collision gas and pressure | Argon, 270 kPa |
| Pause Time | 1 ms |
| Dwell Time | 1 ms |

A 7% (weight/volume) solution of polyacrylonitrile (PAN) in dimethylformamide (DMF) was prepared and will be referred to as the coating binder. A slurry with a composition of 9.2% 1.3 &micro;m HLB particles, 87.9% of coating binder, and 2.8% glycerol by weight was then prepared. PESI probes were etched by sonication in dilute HCl (7.4%) for 15 min. The probes were then sonicated in water for 20 min followed by sonication in LC grade MeOH for another 20 min. The etched probes were then dried in a convection oven at 125&#730;C and were coated the same day as the etching. The etched PESI probes were dip-coated with the HLB-PAN slurry using an in-house built stage. The tips of the probes were coated with a length of 2 mm and dried in a convection oven at 90&#730;C. This coating process was repeated until a coating thickness of 6.5 &micro;m was achieved. Prior to using the coated PSEI probes for extractions, the probes were cleaned with a MeOH/ACN/IPA (v/v/v 2/1/1) mixture for 15 min, followed by conditioning with MeOH/H₂O (v/v 1/1) for 15 min.

All experiments performed in Example 2 used 300&micro;L aliquots of PBS spiked with 10 ng mL⁻¹ of standards as samples. In between extraction and desorption, the probes were rinsed with H₂O for 3 s and air dried. All experiments also used 50 &micro;L of MeOH/ACN (v/v 4/1) as the desorption solution for subsequent LC-MS/MS analysis. All extractions and desorptions were static and performed at room temperature.

ETP of the coated PESI probes in PBS was constructed using the following extraction times in triplicate: 10, 30, 60, 90, and 120 min. Extraction was followed by a 3 s rinse in H₂O and a 30 min desorption.

Desorption time profile (DTP) of the coated PESI probes in PBS was constructed via extraction using the optimal extraction time. Afterwards the following time points for desorption were tested in triplicate: 10, 30, 45, 60, and 75 min. Subsequently a second desorption was conducted immediately after the first with fresh desorption solvent for 75 min. The second desorption was used to assess carryover of the analyte.

Intra-probes reproducibility was tested by five cycles of extraction and desorption of coated PESI probes using optimized extraction and desorption conditions. Inter-probe reproducibility was determined by grouping the probes from the intra-probe reproducibility test by their extraction and desorption cycle.

In Example 2, 90 min static extractions at room temperature were performed using 300 &micro;L PBS spiked with 10 ng mL⁻¹ standards as samples. The extraction was followed by a rinse with H₂O for 3 s and air drying the coated PESI probes.

The desorption solution for SPME-PESI-MS/MS was optimized by placing the dry extracted probe into the DPiMS-8060 interface and 10 &micro;L of desorption solution was applied to the sample plate. Finally, an SPME-PESI-MS/MS run was conducted. The desorption solutions tested varied in ratios of water to organic solvent with 0.1% formic acid. The organic solvents used were ACN, IPA, and MeOH.

To test depletion of the coated PESI probes by SPME-PESI-MS/MS three distinct scenarios were used after extraction, rinsing, and drying the coated PESI probes as follows below:

1) The coated PESI probes underwent a 30 min static desorption into 50 &micro;L MeOH/ACN (v/v 4/1) for LC-MS/MS analysis.

2) The coated PESI probes were used for SPME-PESI-MS/MS using 10 &micro;L of the optimized desorption solvent. Following this the coated PESI probes underwent a 30 min static desorption into 50 &micro;L MeOH/ACN (v/v 4/1) for LC-MS/MS analysis.

3) The coated PESI probes were used for SPME-PESI-MS/MS two consecutive times using the optimal desorption solvent. Following this the coated PESI probes underwent a 30 min static desorption into 50 &micro;L MeOH/ACN (v/v 4/1) for LC-MS/MS analysis.

All plasma samples when spiked with analytes were incubated in a 4&#730;C refrigerator overnight to allow for adequate binding with plasma.

Extraction time profile of the coated PESI probes was conducted using aliquots of 30&micro;L plasma spiked with 10 ng mL⁻¹ of standards were statically extracted for the following time points: 10, 30, 45, 60, 75, and 90 min. Extraction was followed by a 3 s rinse and a 30 min static desorption in 50 &micro;L MeOH/ACN (v/v 4/1) for LC-MS/MS analysis.

SPME-PESI-MS/MS was used to construct calibration curves by extracting 30 &micro;L of plasma with 10 ng mL⁻¹ of internal standards and the following concentrations of standards: 1, 5, 10, 25, 50, 75, 100 ng mL⁻¹. Precision and accuracy were determined by three different QC levels which were plasma spiked with the following concentrations of standards: 3, 30, and 90 ng mL⁻¹. Five replicates were used per calibration level and QC level.

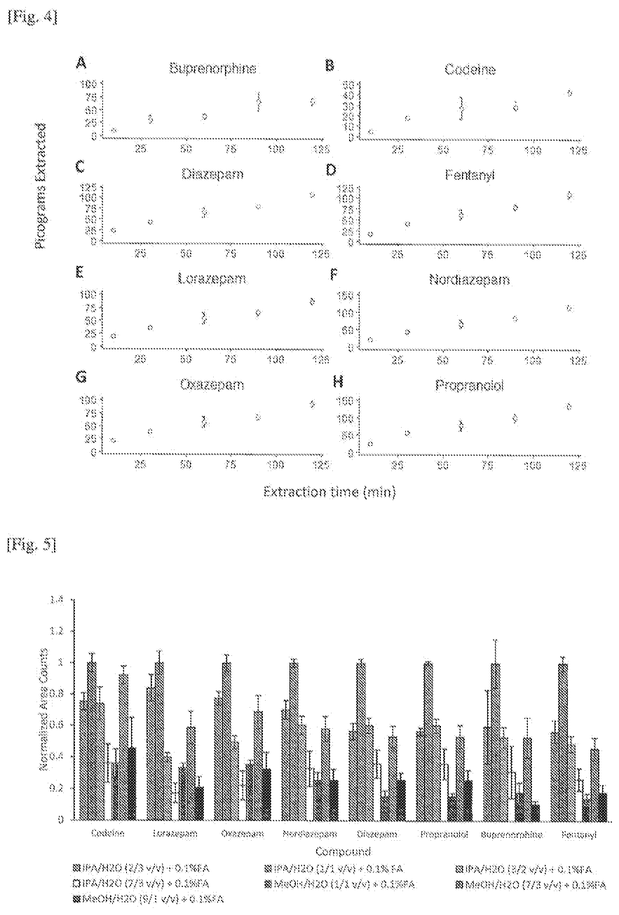

The first major objective was to investigate the reproducibility of coating the PESI probes. Before conducting intra- and inter- probe reproducibility ETP and DTP were performed to ensure adequate signal was obtained and carryover of analytes are minimized. The initial ETP attempted using agitation, however the reproducibility was poor therefore static extractions and desorptions were used. This may be due to the lack of control over the coated PESI probe contacting the sample or desorption solvent. ETPs were determined by the static extraction from PBS spiked with 10 ng mL⁻¹ of standards using time points ranging from 10 &#8211; 120 min. ETPs can be found in FIG. 4 and based on these results 90 min was selected as the optimized extraction time despite the compounds not reaching equilibrium. A 90 min static extraction was used as the optimal time as it allowed for the completion of five consecutive extraction and desorption cycles for the inter and intra probe reproducibility in a practical time frame while attaining high sensitivity. The DTP was determined by the static extraction of spiked PBS for 90 min followed by the desorption for the following time points: 10, 30, 45, 60, and 75 min. A second static desorption step was carried out to assess the carryover of analytes. Results of the desorption time profile experiment show that all analytes are desorbed quantitatively at 10 min. However, the carryover test shows that all compounds carryover percentages of 3.5% or less except propranolol and buprenorphine which had relatively high carryover percentages of 5.0 and 5.3% respectively. Therefore, a desorption time of 30 min was considered as the best desorption time, where all compounds had carryover at or under 3.2%. FIG. 4 shows the extraction time profile of drugs of abuse in PBS (A) buprenorphine, (B) codeine, (C) diazepam, (D) fentanyl, (E) lorazepam, (F) nordiazepam, (G) oxazepam, and (H) propranolol. Extractions were conducted statically on 300&micro;L PBS (spiked with 10 ng mL−1 of standards, n=3) for the following time points: 10, 30, 60, 90, and 120 min. Desorption was conducted statically using 50 &micro;L of MeOH/ACN (4/1 v/v) for 60 min. Analysis was performed via LC-MS/MS.

Intra-probe reproducibility was conducted by five consecutive extraction and desorption cycles using a 90 min extraction time and 30 min desorption time. The intra-probe reproducibility was used to observe the stability of the coated probes and the reusability of the probes. Intra-probe reproducibility was excellent as shown in Table 2.6. Good intra-probe reproducibility was demonstrated by 34 instances where relative standard deviations (RSDs) were 10% or less, 4 instances where RSDs were between 10 &#8211; 15%, and two instances where RSDs were between 15 &#8211; 20%. Inter-probe reproducibility was determined by grouping the results of the intra-probe reproducibility by the extraction and desorption cycle. The results of the inter-probe reproducibility show good reproducibility of the etching and coating process as shown in Table 2.7. Good inter-probe reproducibility was demonstrated by 26 instances where RSDs were 10% or less, 11 instances where RSDs were between 10 &#8211; 15%, 6 instances where RSDs were between 15 &#8211; 20% and one instance where the RSD was 21%. When compared to the SPME mini tips, a similar device the inter- and intra-probe reproducibility were equal or lower than said literature values. Vasiljevic et al. assessed intra-tip reproducibility for SPME mini tips by evaluating the RSDs of five extraction and desorption cycles using 200 ng mL⁻¹ of diazepam, nordiazepam, oxazepam, and lorazepam. Only 7 out of the 20 2.1 RSDs for the said compounds were 10% or less for the SPME-mini tips. In comparison for the coated PESI probes 18 out of the 20 RSDs for the said compounds were 10% or less. For the inter-tip reproducibility test for the SPME mini tips the lowest RSD between diazepam, lorazepam, nordiazepam, or oxazepam was 18% while the highest RSD for the coated PESI probes for the said compounds was 16%.

TABLE 2.6
Intra-probe reproducibility of coated PESI probes

| Probe | RSD (%) n = 5 | | | | | | | |
|---|---|---|---|---|---|---|---|---|
| Number | Buprenorphine | Codeine | Diazepam | Fentanyl | Lorazepam | Nordiazepam | Oxazepam | Propranolol |
| 1 | 16 | 10 | 6 | 8 | 4 | 5 | 4 | 6 |
| 2 | 12 | 3 | 7 | 9 | 5 | 6 | 6 | 8 |
| 3 | 7 | 10 | 9 | 10 | 7 | 9 | 8 | 9 |
| 4 | 6 | 15 | 5 | 4 | 10 | 8 | 10 | 7 |
| 5 | 9 | 20 | 5 | 4 | 11 | 6 | 11 | 6 |

TABLE 2.7
Inter-probe reproducibility of coated PESI probes

| Extrachon | RSD (5) n = 5 | | | | | | | |
|---|---|---|---|---|---|---|---|---|
| Cycle | Buprenorphine | Codeine | Diazepam | Fentanyl | Lorazepam | Nordazepam | Oxazepam | Propranolol |
| 1 | 7 | 14 | 7 | 6 | 7 | 7 | 6 | 6 |
| 2 | 5 | 20 | 8 | 7 | 14 | 10 | 13 | 8 |
| 3 | 15 | 21 | 14 | 15 | 15 | 14 | 16 | 15 |
| 4 | 11 | 7 | 9 | 11 | 6 | 9 | 7 | 9 |
| 5 | 7 | 8 | 3 | 4 | 4 | 3 | 4 | 5 |

With the extraction conditions optimized for SPME-PESI-MS/MS via the ETPs described above, the desorption solvent was optimized for SPME-PESI-MS/MS. The following desorption solutions were tested: ACN/H₂O (v/v 9/1), ACN/H₂O (v/v 7/3), ACN/H₂O (v/v 1/1), IPA/H₂O (v/v 9/1), IPA/H₂O (v/v 7/3), IPA/H₂O (v/v 3/2), IPA/H₂ O (v/v 1/1), IPA/H₂O (v/v 2/3), MeOH/H₂O (v/v 9/1), MeOH/H₂O (v/v 7/3), and MeOH/H₂O (v/v 1/1). All solvents listed above had 0.1% FA added as a modifier. FIG. 5 shows the results of these experiments using normalized area counts. Area counts were normalized by dividing area counts for all desorption solvents for a particular compound by the desorption solvent that gave the highest average area count. Data for ACN/H₂O (v/v 9/1), ACN/H₂O (v/v 7/3), ACN/H₂O (v/v 1/1), and IPA: H₂O (v/v 9/1) were not included in FIG. 5. These data points were excluded due to the inconsistency in the generation of spray events when using these desorption solvents. The desorption solvent IPA/H₂O (v/v 1/1)+0.1% FA was chosen as the optimal desorption solvent as it gave the highest area counts for all eight compounds. Unlike other SPME based ambient mass spectrometry technologies such as CBS the organic solvent used was IPA compared to MeOH. The amount of desorption solvent applied onto the coated PESI probe by the repetitive pick and spray method is heavily influenced by the surface tension and viscosity of the desorption solvent. There is a positive correlation between the increase in surface tension and viscosity with an increase of the amount of sample picked and retained onto the surface of a PESI probe. The desorption solvent must also be able to sufficiently wet the coating of the SPME PESI probe to allow for adequate transfer of analytes from the coating into the desorption solvent.

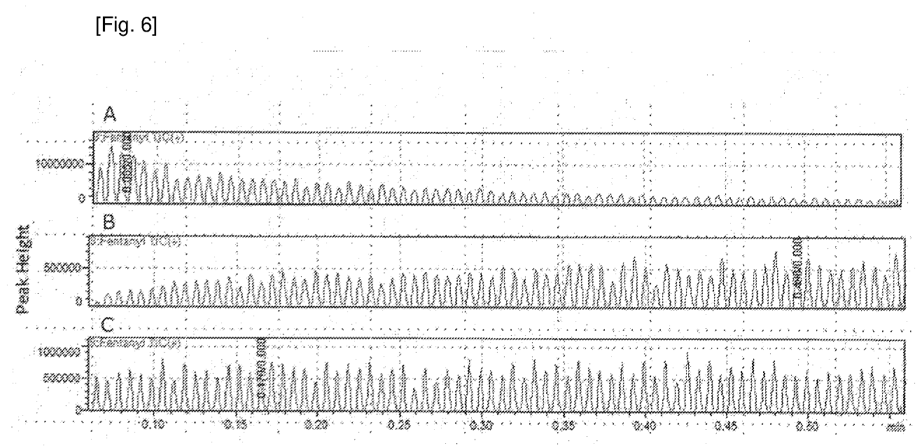

FIG. 6 illustrates the difference between the electrospray patterns of SPME-PESI-MS/MS and PESI-MS/MS. The signal height is roughly constant for uncoated PESI probes (FIG. 6 at C). The signal height for the coated PESI probes when sampling analytes spiked into the sample plate as if it were uncoated PESI probes show an increase in signal height until the 9 s mark afterwards the signal height is constant (FIG. 6 at B). The signal height decreases throughout the SPME-PESI-MS/MS run when running extracting spiked PBS (FIG. 6 at A). The hypothesis for this decrease in FIG. 6 at A was that significant depletion of the analytes extracted on the coated PESI probe occurred during SPME-PESI-MS/MS.

In FIG. 6, the peak heights from the selected ion monitoring of fentanyl (m/z 337.2) are for: (A) A coated PESI probe statically extracted 300 &micro;L of PBS spiked with 10 ng mL¹ fentanyl for 90 min, followed by a 3 s rinse in H₂O. Then the coated probe was desorbed using 10 &micro;L of IPA/H₂O (1/1 v/v)+0.1% FA applied to a PESI sample plate by SPME-PESI-MS/MS; (B) A coated PESI probe was used for PESI-MS/MS of 10 &micro;L IPA/H₂O (1/1 v/v)+0.1% FA spiked with 10 ng mL⁻¹ fentanyl applied onto a sample plate; and (C) An unmodified PESI probe was used for PESI-MS/MS of 10 &micro;L IPA/H₂O (1/1 v/v)+0.1% FA spiked with 10 ng mL⁻¹ fentanyl applied onto a sample plate.

This hypothesis of whether extracted coated PESI probes were significantly desorbed by SPME-PESI-MS/MS was tested by the extraction of spiked PBS sample followed by either of the three scenarios; directly desorbed for LC-MS/MS, used for one SPME-PESI-MS/MS run followed by desorption for LC-MS/MS, or used for two consecutive SPME-PESI-MS/MS runs followed by desorption for LC-MS/MS. Results from this experiment are shown in Table 2.8 expressed as depletion percentages. Depletion percentages are expressed relative to the area counts given by coated probes that were directly desorbed for LC-MS/MS without any SPME-MS/MS experiments (equation 1). One SPME-PESI-MS/MS run shows at least a 45% desorption of a given compound. Interestingly two consecutive SPME-PESI-MS/MS runs do not show a larger desorption percentage compared to just one SPME-PESI-MS/MS experiment. The desorption percentages are relatively similar. Throughout a single SPME-PESI-MS/MS run it is most likely that the sharp decrease in signal height is due to less analytes on the coating as the run progresses. This is also shown in Table 2.9 where the decrease in area count in the second consecutive SPME-PESI-MS/MS run is expressed relative to the area count in the first SPME-PESI-MS/MS run calculated by equation 2. All analytes show at least a 77% decrease in area count for the second consecutive SPME-PESI-MS/MS run. This also means a single coated PESI probe cannot be used for screening and confirmation analysis by SPME-PESI-MS/MS followed by LC-MS/MS, respectively.

TABLE 2.8
Desorption of Analytes from Coated Probes byy SPME-PESI-MS/MS Analyzed Using
LC-MS/MS

| Number of | | | | | | | | |
|---|---|---|---|---|---|---|---|---|
| SPME-PESI- | Percentage Desorption (%) n = 5 | | | | | | | |
| MS/MS runs | Buprenorphine | Codeine | Diazepam | Fentanyl | Lorazepam | Nordiazepam | Oxazepam | Propranolol |
| 1 | 78 | 68 | 57 | 57 | 61 | 54 | 57 | 46 |
| 2 | 77 | 67 | 65 | 60 | 67 | 62 | 65 | 50 |

$$\begin{matrix}Equation 1 & \\ Percent Desorption = ( 1 - \frac{\begin{matrix}Area count after \\ SFME - PESI - \frac{MS}{MS} run 2\end{matrix}}{\begin{matrix}Area count without \\ SPME - PESI - \frac{MS}{MS} run 1\end{matrix}} ) * 100 \% & ( 1 )\end{matrix}$$

TABLE 2.9
Desorption of Analytes from Coated Probes by SPME-PESI-MSMS Between
Successive Runs

| | Buprenorphine | Codeine | Diazepam | Fentanyl | Lorazepam | Nordiazepam | Oxazepam | Propranolol |
|---|---|---|---|---|---|---|---|---|
| Decrease | 89 | 77 | 80 | 81 | 85 | 80 | 81 | 81 |
| of Signal | | | | | | | | |
| (%) (n = 5) | | | | | | | | |

$$\begin{matrix}Equation 2 & \\ Decrease of Signal = ( 1 - \frac{\begin{matrix}Area count after \\ SFME - PESI - \frac{MS}{MS} run 2\end{matrix}}{\begin{matrix}Area count without \\ SPME - PESI - \frac{MS}{MS} run 1\end{matrix}} ) * 100 \% & ( 2 )\end{matrix}$$

The shape of the signal for SPME-PESI-MS/MS illustrated by FIG. 6 at A is due to a single pick and spray not being sufficient for complete desorption of analytes. The desorption of analytes from the coating to the desorption solvent is a partitioning process, where at equilibrium the equations below apply:

$$\begin{matrix}Equation 3 & \\ Elu . = \frac{1}{1 + {K}_{fe}} \frac{{V}_{f}}{{V}_{e}} & ( 3 )\end{matrix}$$

$$\begin{matrix}Equation 4 & \\ {C}_{e} = \frac{{n}_{f}}{{V}_{e} + {K}_{fe} {V}_{f}} & ( 4 )\end{matrix}$$

Based on equation (3), the ratio of analyte desorbed from the coated PESI probe, Elu.

is dictated heavily by the desorption solvent volume, Ve, when using coated PESI probes with a constant coating volume, Vf. Based on this equation the desorption of nearly all the analytes into the desorption solvent for LC-MS/MS analysis occurs due its relatively high volume of desorption solvent when compared to the coating volume. Based on the equation only a fraction of analytes are desorbed during a single pick and spray for SPME-PESI-MS/MS (equation 4). The amount of desorption solvent picked by SPME-PESI-MS/MS is probably in the same range as the amount of sample picked by PESI-MS/MS which is in the pL range. This explains why each pick and spray for a coated PESI probe has observable signals for both its consecutive uses in SPME-PESI-MS/MS and signal for a subsequent LC-MS/MS run. The decrease in peak area and peak height in only a few pick and spray cycles for SPME-PESI-MS/MS can be related to the moles of analytes remaining on the coated PESI probe if the desorption volume picked is constant between pick and spray cycles as described by equation 4. Each subsequent desorption will have a lower number of moles of analyte remaining on the coated PESI probe therefore the concentration of analytes in the desorption solvent, Cₑ will also decrease.

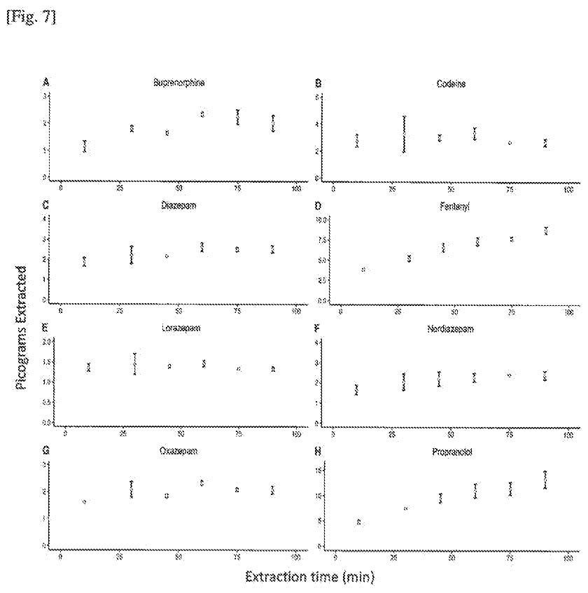

SPME-PESI-MS/MS was then applied to quantitate drugs of abuse in a small volume of plasma. The purpose of using plasma was to demonstrate analyte quantitation from a complex matrix where its constituents bind to the analytes and can cause ion suppression even if they are extracted in moderate amounts. The ETP of 30 &micro;L of spiked plasma was conducted and resulted within an optimal time of 60 min as shown in FIG. 7 due to most compounds reaching equilibrium at this time. FIG. 7 shows an extraction time profile of drugs of abuse from small volume plasma samples by LC-MS/MS of: (A) Buprenorphine, (B) Codeine, (C) Diazepam, (D) Fentanyl, (E) Lorazepam, (F) Nordiazepam, (G) Oxazepam, and (H) Propranolol.

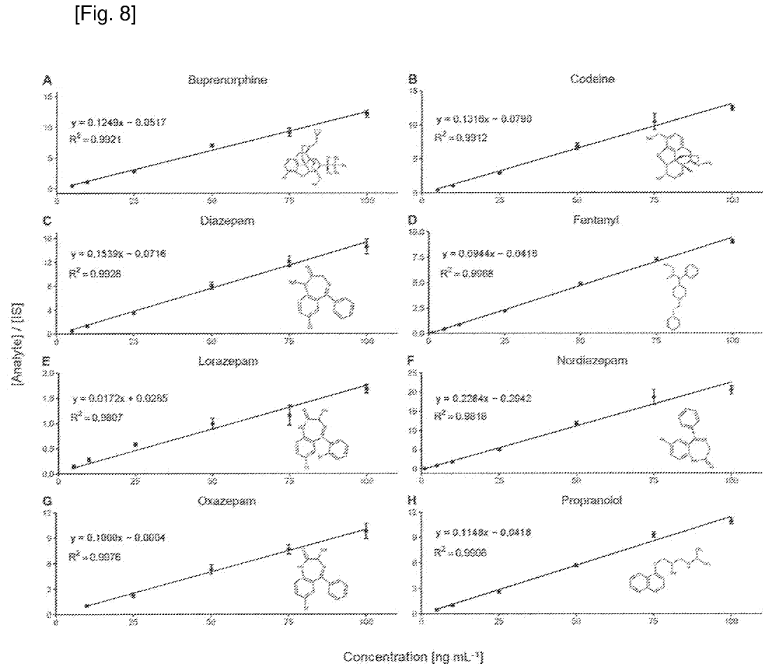

Afterwards, a calibration curve with seven different calibration levels with five replicates per level was constructed. Calibration curves constructed were weighted by a factor of 1/x. Table 2.10 contains factors for the line of best fit while Table 2.11 contains the other figures of merit. FIG. 8 contains the calibration curves for the eight drugs of abuse. Intra- and inter-day precision and accuracy were assessed using three distinct levels with five replicates per levels: low, middle, and high (3, 30, 90 ng mL⁻¹). FIG. 8 shows calibration curves from extracting drugs of abuse from small samples of plasma followed by analysis by SPME-PESI-MS/MS of: (A) Buprenorphine, (B) Codeine, (C) Diazepam, (D) Fentanyl, (E) Lorazepam, (F) Nordiazepam, (G) Oxazepam, and (H) Propranolol. The calibration curves show linearity with R² values all above 0.9800 with six calibration curves showing R² values above 0.9900. LOQ of the drugs of abuse were calculated by determining the lowest calibration point with a signal to noise ratio of 10 or above. Nordiazepam and fentanyl had a LOQ of 1 ng mL⁻¹. Buprenorphine, codeine, diazepam, lorazepam, and propranolol had a LOQ of 5 ng mL⁻¹. Oxazepam had a LOQ of 10 ng mL⁻¹. Intraday precisions were under 15% for all compounds for concentrations above their respective LOQs. Inter-day precisions were under 15% for all compounds except for the middle level of lorazepam and the high level of oxazepam which were 16 and 27% respectively. Accuracies were between 80 &#8211; 120% for all compounds for concentrations above their respective LOQs except for the middle level of lorazepam which was 122%.

TABLE 2.10
Linearity of Drugs of Abuse Extracted from Small
Volumes of Plasma by SPME-PESI-MS/MS

| | Range | LOQ | | | |
|---|---|---|---|---|---|
| Compound | (ng/mL) | (ng/mL) | slope | intercept | R² |
| Buprenorphine | 5-100 | 5 | 0.1249 | −0.0517 | 0.9921 |
| Codeine | 5-100 | 5 | 0.1316 | −0.0790 | 0.9912 |
| Diazepam | 5-100 | 5 | 0.1539 | −0.0716 | 0.9928 |
| Fentanyl | 1-100 | 1 | 0.0944 | −0.0418 | 0.9968 |
| Lorazepam | 5-100 | 5 | 0.0172 | 0.0285 | 0.9807 |
| Nordiazepam | 1-100 | 1 | 0.2284 | −0.2942 | 0.9818 |
| Oxazepam | 10-100 | 10 | 0.1000 | −0.0004 | 0.9976 |
| Propranolol | 5-100 | 5 | 0.1148 | −0.0418 | 0.9908 |

TABLE 2.11
Precision and Accuracy for Drugs of Abuse Extracted from Small Volumes of Plasma
by SPME-PESI-MS/MS

| | Intra-day Precision (%) | | | Inter-day Precision (%) | | | Accuracy (%) | | |
|---|---|---|---|---|---|---|---|---|---|
| Compound | Low | Middle | High | Low | Middle | High | Low | Middle | High |
| Buprenorphine | BQL | 8 | 9 | BQL | 8 | 12 | BQL | 90 | 103 |
| Codeine | BQL | 14 | 7 | BQL | 6 | 8 | BQL | 96 | 101 |
| Diazepam | BQL | 6 | 10 | BQL | 6 | 8 | BQL | 91 | 107 |
| Fentanyl | 4 | 3 | 2 | 4 | 3 | 4 | 93 | 94 | 105 |
| Lorazepam | BQL | 13 | 13 | BQL | 16 | 12 | BQL | 122 | 105 |
| Nordiazepam | 9 | 4 | 6 | 8 | 11 | 8 | 96 | 89 | 98 |
| Oxazepam | BQL | 9 | 11 | BQL | 13 | 27 | BQL | 87 | 99 |
| Propranolol | BQL | 3 | 2 | BQL | 3 | 5 | BQL | 93 | 100 |

BQL is below quantifiable level.
The concentrations of the low, middle, and high validation points are 3, 30, and 90 ng ml⁻¹.

In Example 2, the first investigation explored which desorption solvent gives the best signal and the factors that influence these. The second investigation was to prove that SPME-PESI-MS/MS depletes the extracted probe and to explore why the ion chromatogram resembles the shape of a decay curve. The third investigation was to prove if SPME-PESI-MS/MS can be used to construct calibration curves. Afterwards SPME-PESI-MS/MS was used to analyze drugs of abuse from small volumes of plasma without any additional pre-treatment steps. Linearity measured by R² values exceeded 0.9900 for 6 of the 8 drugs of abuse and for the remaining 2 drugs of abuse R² values above 0.9800 was observed. LOQ obtained for fentanyl and nordiazepam were 1 ng mL⁻¹, while the LOQ obtained for buprenorphine, codeine, diazepam, lorazepam, and propranolol were 5 ng mL⁻¹, and the LOQ obtained for oxazepam was 10 ng mL⁻¹.

### Example 3

Free concentration or PPB is obtained by SPME-PESI-MS/MS. The rationale behind using this technique is two-fold. The first reason is that other SPME based AIMS techniques for example CBS uses a much larger extraction phase which would disturb the equilibrium between the drug and the matrix. The volume of sample needed for most SPME based AIMS techniques to extract negligible amounts of a therapeutic agent (under 1% recovery) is generally not practical for clinical cases. In the case of SPME-PESI-MS/MS the coating is relatively small therefore less likely to deplete the target drug from the sample based on previous studies. Secondly the use of nano-ESI emitters to couple small SPME fibers directly to a MS is prone to the possibility of clogging. SPME-PESI-MS/MS on the other hand is not prone to clogging. The measurement of PPB by any AIMS techniques was not reported in publication yet during the writing of this thesis.

LC-MS grade ACN, IPA, MeOH, and H₂O were purchased directly from Fisher Scientific (Bartlesville, Okla., USA). FA, sodium chloride, potassium chloride, potassium phosphate monobasic, sodium phosphate dibasic, hydrochloric acid, HPLC grade MeOH were purchased from Sigma Aldrich (Oakville, ON, Canada). The following chemical were purchased from Sigma Aldrich (Oakville, ON, Canada) specifically for the synthesis of 1.3 &micro;m HLB particles; divinylbenzene, N-vinylpyrrolidone, and 2,2-Azobis(isobutyronitrile). Diazepam and diazepam-d₆ were purchased from Cerilliant Corporation (Round Rock, Tex., USA). Frozen, pooled gender, non-filtered human plasma with K₂EDTA as the anticoagulating agent was purchased from Bioreclamation IVT (Westbury, N.Y., USA).

Methanolic working standards were prepared from the stock solutions of diazepam and diazepam-d₆. Plasma and PBS samples were spiked such that no more than 1% organic working standard was added. This was done to ensure that no alterations occurred in the matrix that can measurably affect either the equilibrium constant between the coated probe and the sample or the plasma protein binding of the analyte. Working standards were stored in −80 &#730;C. All plasma samples when spiked with analytes, and then incubated at 4 &#730;C for a minimum of 12 hours to allow for adequate binding with the plasma.

An in-house built stage equipped with a motor (MTS50/M-Z8E, 50 mm) from ThorLabs Inc. (Newton, Mass., USA) was used for dip coating the PESI probes. A VWR Thermal Shake Touch benchtop agitator was used when maintaining a temperature of 37 &#730;C during static extractions. Before extractions, spiked plasma or PBS samples were heated to 37&#730; for 30 min with no agitation with the benchtop agitator.

The LC-MS/MS instrumentation and method of Example 3 is similar to that of Example 2. The only modification is that only transitions for diazepam and diazepam-d₆ were used. See Example 2 above for the coating procedure for the PESI probes.

ETPs of coated PESI probes in PBS or plasma were determined by the static extraction of 1.5 mL aliquots of sample spiked with 10 ng mL⁻¹ of diazepam held at 37&#730;C for the following time points in triplicates: 10, 30, 45, 60, 75, and 90 min. Following the extraction, the probes were rinsed for 3 s with H₂O, and then statically desorbed for 30 min in 50 &micro;L MeOH/ACN (v/v 4/1). The extracts were then analyzed by LC-MS/MS. PPB was calculated using the equation below:

$$\begin{matrix}Equation 5 & \\ PPB = ( 1 - \frac{[ Concentration from plasma ]}{[ Concentration from PBS ]} ) * 100 & ( 5 )\end{matrix}$$

A calibration curve with IS correction and a weighting of 1/x was constructed using the following concentrations of diazepam spiked in 1.5 mL aliquots of PBS (n=5): 0.05, 0.1, 0.25, 1, 5, 10, and 25 ng mL⁻¹ using a 60 min static extraction at 37° C. Aliquots of 1.5 mL plasma spiked with 25 ng mL⁻¹ diazepam (n=5) were also analyzed using the above extraction conditions. After extraction, a 3s rinse with H₂O was conducted followed by air drying. The dried probes were used for SPME-PESI-MS/MS using 10 &micro;L of IPA/H₂O (v/v 1/1)+0.1% FA. The calibration curve constructed from PBS extracts was used to calculate the free concentration of diazepam from the plasma sample using equation (5).

Before starting any experiments with SPME-PESI-MS/MS, the capability of the coated PESI probes to measure the PPB of diazepam from human plasma was evaluated by LC-MS/MS. ETPs for PBS and plasma were constructed from the LC-MS/MS experiments as shown in FIG. 9. Based on FIG. 9 at A, the equilibrium time for static extraction of diazepam from PBS at 37 &#730;C was approximately 60 min. The equilibrium time for the static extraction of diazepam from plasma at 37 &#730;C was approximately 30 min based on FIG. 9 at B. The recovery of diazepam from PBS and plasma were determined by dividing the ng extracted by the coated PESI probe at the 60 min time point calculated using an instrumental calibration curve by the ng of diazepam spiked into the sample. The recovery of diazepam from PBS and plasma at 60 min were 0.90% and 0.015% respectively. This is under the 1% recommended recovery limit to prevent depletion of the sample. Depletion of the analyte from the sample can result in changes to the “true” equilibrium between the free and bound concentrations of analytes in the matrix. This will ultimately lead to an incorrect determination of the PPB because the new equilibrium will not reflect the actual free concentration and PPB. The PPB of diazepam obtained by LC-MS/MS analysis was 98.4±0.5%, 98.2±0.2%, and 98.4±0.2% for the time points 60, 75, and 90 min, respectively. This was calculated by equation (3) using concentrations of extracted diazepam calculated from an instrumental calibration. When compared to literature values, there is close agreement, with reported PPBs ranging from 97-99% in human plasma. Therefore, capability of determining PPB by the coated PESI probes were confirmed by LC-MS/MS from these experiments. Therefore, PPB experiments by SPME-PESI-MS/MS can be conducted.

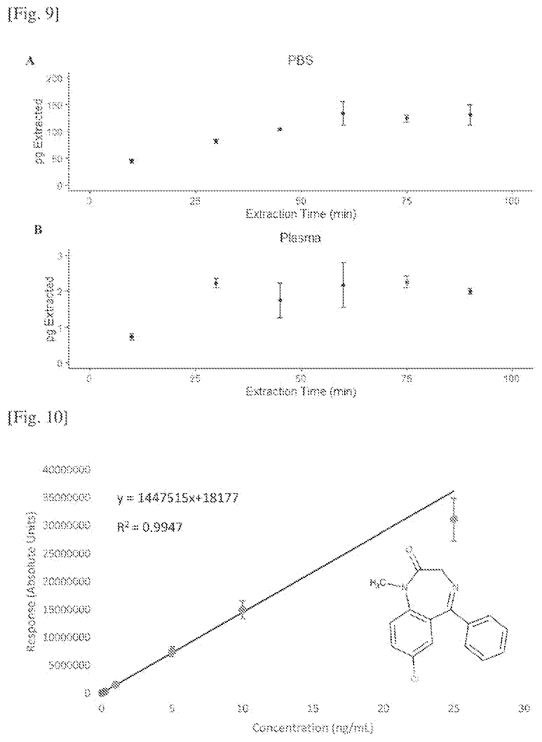

The calibration curve constructed by SPME-PESI-MS/MS (FIG. 10) by extracting spiked PBS with diazepam was used to calculate a PPB of 99.3±0.2% which was similar to the PPB of 98.4±0.5% calculated in the previous Example 2 for the same extraction times. The calibration curve had a high linearity based on an R² of 0.9947 and RSDs of <14%. The concentrations of diazepam from plasma and PBS used to calculated PPB were calculated using the linear regression from FIG. 10. The PPB calculated for diazepam by SPME-PESI-MS/MS was within the literature values of 97-99%.

Based on the agreement of the PPB values generated by SPME-PESI-MS/MS and LC-MS/MS of 99.3±0.2% and 98.4±0.5%, respectively, and its agreement with reported literature values of 97-99%. Therefore, SPME-PESI-MS/MS has been demonstrated to be an effective tool for accurately calculating the PPB and determining the free concentration of diazepam. The ability to conduct AIMS workflows that can determine the free concentration, have high throughput, and have lower workflow times compared to LC-MS/MS methods provide an attractive alternative to current therapeutic drug monitoring methods that rely on determining total concentration.

### Example 4

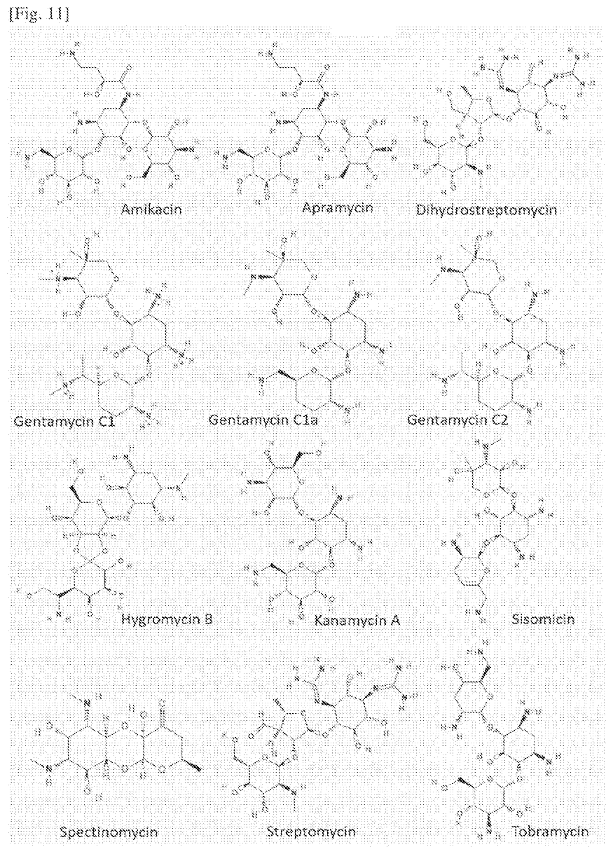

In Example 4, the probe was tested using aminoglycosides, a class of broad-spectrum antibiotics that inhibit protein synthesis. Aminoglycosides are generally characterized by linking at least two amino sugars via a glycosidic bond with an aminocyclitol ring as shown in FIG. 11. These compounds are very hydrophilic, highly water-soluble and were among the first antibiotics to be used clinically. However, their cochleotoxicity, nephrotoxicity, ototoxicity, and vestibulotoxicity led a shift away from their prescription towards less toxic antibiotics. However, in recent years there has been a shift towards the increased prescription of aminoglycosides for clinical use due to the rise of multi-resistant microbes and a better understanding of dosage regimes for aminoglycosides. While better dosage regimes help mitigate toxic side effects when used clinically, these compounds are also used in widespread practice as veterinary drugs for farm animals. Veterinary drugs are used in modern farming practices for treating infection or infection prevention. Aminoglycosides as veterinary drugs when misused can be found in foodstuff at residual levels. Despite the residual levels, the toxicity of aminoglycosides may possess human risk. To regulate aminoglycoside misuse as veterinary drugs, different jurisdictions regulate the use of these compounds through regulations such as Council Directive 96/23/EC.

Aminoglycosides are non-metabolizable agents and thus a substantial amount of the original molecules excreted to the environment by living organisms. There are several alternative sources like emissions by hospitals or pharmaceutical company, incomplete elimination in sewage treatment plants, and extensive abuse in farming and aquaculture are also available that have been released considerable amounts of aminoglycosides into the environment. Their presence in the aquatic environment especially drinking water is considered a potential risk. Therefore, aminoglycosides have received great attention towards monitoring their presence in aquatic environments and wastewater effluent to ensure the quality of various types of water samples. Monitoring the residual level of aminoglycosides in the aquatic environment particularly wastewater effluents allows for a better understand regarding the usage of aminoglycosides and the rise of aminoglycoside resistance in bacteria. On the other hand, the monitoring of aminoglycosides in the aquatic environment is a challenging task as they are highly hydrophilic and water-soluble. The detection, monitoring, and quantification of aminoglycosides in all three areas of clinical samples, foodstuff, and water have driven the development of analytical methods that are fit for purpose.

Analytical methods giving reasonable qualitative and quantitative monitoring of multiple aminoglycosides are difficult due to the certain combination of properties they possess. The lack of a chromophore and fluorophore make certain types of detectors such as UV or fluorescence difficult without derivatization steps. The multiple amino and hydroxyl groups that aminoglycosides contain cause high hydrophilicity which also makes it difficult to incorporate into multiresidue methods. This was highlighted in a series of articles published by Desmarchelier and colleagues where the determination of aminoglycosides required a completely different sample preparation and LC method for proper screening compared to the other veterinary drugs. When multiple aminoglycosides are determined by LC-MS the methods tend to use either ion pairing or hydrophilic interaction liquid chromatograph (HILIC) for separation. The drawbacks of using ion pairing reagents are that they are difficult to remove from the LC-MS, usually not volatile, cause ion suppression, and containment the ion source. The drawbacks of using HILIC columns stem particularly from the use of zwitterionic columns where large concentrations of salt are needed in addition to FA for proper separation of aminoglycosides. These drawbacks include the use of large concentrations of salt leading to salt precipitation, high organic solvent percentages which lead to poor solubility of aminoglycosides, and long equilibration times. Overall the drawbacks to both ion pairing and HILIC in the case of aminoglycoside analysis leads to more maintenance of the LC-MS system and reduced operational time. To overcome these issues, AIMS can be used as a screening tool to determine the presence of aminoglycosides. The lack of chromatography and shorter workflow times leads to a screening method that is more economical than LC-MS based screening method as there is no use of high salt concentrations or ion-pairing reagents. To ensure proper sensitivity is reached sample preparation is used to preconcentrate and extract analyte.

In Example 4, SPME-PESI-MS/MS was developed to qualitatively screen aminoglycosides from water. The detection of aminoglycosides by SPME techniques are sparse. The hydrophilic nature of aminoglycosides demands the use of specialized coatings. For this study, a nitrogen-rich organic polymer was used for the coating of the PESI probes, and various parameters were optimized for the screening of aminoglycosides in water.

The following LC-MS grade chemicals were purchased from Fischer Scientific (Bartlesville, Okla., USA): acetone, ACN, IPA, MeOH, and H₂O. Reagent grade dimethylsufoxide (DMSO) was purchased from Sigma Aldrich. The following chemicals were purchased from Sigma Aldrich (Oakville, ON, Canada): acetic acid, FA, hydrochloric acid, LC grade MeOH, N,N-diisopropylethylamine, potassium phosphate dibasic, potassium phosphate monobasic, sodium acetate, sodium bicarbonate, sodium carbonate, and sodium hydroxide. PESI probes and sample plates were donated by Shimadzu Corporation (Kyoto, Japan).

The following solid standards were purchased directly from Sigma Aldrich (Oakville, ON, Canada): amikacin, apramycin sulfate salt, dihydrostreptomycin sulfate, hygromycin B, gentamicin sulfate salt, kanamycin A sulfate, sisomicin sulfate, spectinomycin sulfate, streptomycin sulfate, and tobramycin. Single standard master stocks of the solid standards were made in water such that the free base concentration was 2 mg mL⁻¹. The master stocks were stored at &#8211; 20 &#730;C. A working stock of 100 &micro;g mL⁻¹ of aminoglycosides in water was serially diluted from the master stocks. It is noted that all standards and samples containing aminoglycosides were stored in polypropylene containers to prevent loss of aminoglycosides due to adsorption with glass.

Acetate buffer was prepared by mixing 1.8 g of sodium acetate and 4.6 mL of acetic acid in 500 mL of H₂O. The pH of the acetate buffer was adjusted to pH 4 by adding additional acetic acid dropwise until the desired pH was reached. Potassium phosphate buffer (pH=6) was prepared by mixing 2.4 g of potassium phosphate dibasic and 11.8 g of potassium phosphate monobasic in 500 mL of H₂O. The potassium phosphate buffer (pH=6) was adjusted to a pH of 6 by adding 1.0M sodium hydroxide dropwise until said pH was reached. Potassium phosphate buffer (pH=7) was prepared by mixing 9.4 g of potassium phosphate dibasic and 6.3 g of potassium phosphate monobasic in 500 mL of H₂O. The potassium phosphate buffer (pH=7) was adjusted to a pH of 7 by adding 1.0M sodium hydroxide dropwise until said pH was reached. Potassium phosphate buffer (pH=8) was prepared by mixing 16.3 g of potassium phosphate dibasic and 0.89 g of potassium phosphate monobasic in 500 mL of H₂O. The potassium phosphate buffer (pH=8) was adjusted to a pH of 8 by adding 1.0M sodium hydroxide dropwise until said pH was reached. Sodium carbonate buffer was prepared by mixing 3.9 g of sodium bicarbonate and 5.7 g of sodium carbonate in 500 mL of H₂O. The sodium carbonate buffer was adjusted to a pH of 10 by adding 1.0M sodium hydroxide dropwise until said pH was reached.

The instrumentation and method for the SPME-PESI-MS/MS of Example 4 is similar to that of Example 2. The only modification is that the MS transition Table 4.1 below was used instead of Table 2.1.

TABLE 4.1
Multiple Reaction Monitoring Parameters for Aminoglycosides

| | | | Precursor | Product | Q1 Pre- | Collision | Q3 Pre-Bias |
|---|---|---|---|---|---|---|---|
| # | Compound | LogP | Ton (m/z) | Ton (m/z) | Bias (V) | Energy | (V) |
| 1 | Spectinomycin | −2.3^{a} | 351.2 | 207.2 | −13 | −22 | −14 |
| 2 | Sisomicin | −4.3^{a} | 448.1 | 254.2 | −11 | −24 | −18 |
| 3 | Gentamycin C1a | −4 ^{a} | 450.1 | 322.2 | −11 | −14 | −23 |
| 4 | Gentamycin C2 | −4.6^{b} | 464.1 | 322.2 | −11 | −15 | −23 |
| 5 | Tobramycin | −5.8 ^{a} | 468.1 | 163.3 | −14 | −25 | −17 |
| 6 | Gentamycin C1 | −4.1^{b} | 478.3 | 322.2 | −10 | −16 | −23 |
| 7 | Kanamycin A | −6.3 ^{a} | 485.2 | 163.2 | −10 | −25 | −11 |
| 8 | Hygromycin B | −6.4 ^{a} | 528.0 | 352.1 | −20 | −24 | −17 |
| 9 | Apramycin | −6.5 ^{a} | 540.1 | 217.2 | −20 | −26 | −15 |
| 10 | Streptomycin | −6.4 ^{a} | 582.0 | 263.2 | −22 | −32 | −19 |
| 11 | Dihydrostreptomycin | −7.3 ^{a} | 583.8 | 263.2 | −20 | −32 | −19 |
| 12 | Amikacin | −8.6 ^{a} | 586.1 | 163.2 | −22 | −33 | −11 |

^{a}Drug bank accessed in November 2020
^{b}PubChem accessed in November 2020
Pause time and dwell time for all compounds were both 1 msec.
All compounds used [M + H]⁺ adduct except for spectinomycin where the [M + H₂O + H]⁺ was used

Also see Example 2 for the coating procedure for the PESI probes. Two modifications from the method discussed in detail in Example 2 were made. First, the use of nitrogen rich polymeric material was used instead of synthesized 1.3 &micro;m HLB particles. Second, the coating process was repeated until a coating thickness with a radius of 11.5 &micro;m and a length of 3 mm was achieved instead of a coating thickness of 6.5 &micro;m and a length of 2 mm.

In all optimization of screening conditions, 750 &micro;L of final sample after modifications was used for a 90 min static extraction in triplicates. Following the extraction, the probes were dried at room temperature. SPME-PESI-MS/MS was conducted using 10 &micro;L of IPA/H₂O (v/v, 1/1)+0.1% FA as the desorption solvent for pH adjustment and matrix modification experiments. The pH of the spiked water samples were adjusted to the pHs; 4, 6, 7, 8, and 10 using the buffer salts as well as formic acid or N,N-diisopropylethylamine. The concentration of spiked aminoglycosides in the pH modified water samples were 300 ng mL⁻¹ of aminoglycosides. For the matrix modification experiments, initially, water was spiked to contain 300 ng mL⁻¹ of aminoglycosides. The spiked water was mixed with the following organic solvents: acetone, ACN, DMSO, IPA, and MeOH such that the final samples contained a 50/50 split of spiked water and solvent volumetrically. For further matrix modification experiments, the water sample spiked with 300 ng mL⁻¹ of aminoglycosides was modified with DMSO, IPA, and MeOH in a different volumetric ratios (1/3, 1/1, and 3/1) to spiked sample.

For the desorption solvent optimization experiments, the spiked water was modified by the addition of IPA such that the final sample was 3/1 IPA/spiked water (v/v). After extraction, the different compositions of IPA/H₂O ((v/v, 4/1), (v/v, 7/3), (v/v, 3/2), and (v/v, 1/1) all containing 0.1% FA) were tested as desorption solvents to desorb the analytes from the coated PESI probes.

For the rinsing investigations, water was used as a rinsing solvent using the same matrix modification from the desorption solvent optimization. The rinsing was performed immediately after extraction for 3 s. For the desorption, optimized desorption solvent was used for SPME-PESI-MS/MS analysis.

The pH of the extraction sample is an important factor for SPME method development, especially when extracting from aqueous samples. The reason is that only undissociated or neutral analytes are extracted during the SPME process. Therefore, the pH with the highest extraction efficiency for the coated probes will ensure the largest proportion of the neutral aminoglycosides, and result in the highest sensitivity. The pH of the aqueous samples spiked with aminoglycosides was adjusted over the range 4&#8211;10.

The pH modification experiments initially conducted used the following buffers; 0.2 M acetate buffer (pH=4), 0.2 M potassium phosphate buffer (pH=6), 0.2 M potassium phosphate buffer (pH=7), 0.2 M potassium phosphate buffer (pH=8), and 0.2M sodium carbonate buffer (pH=10). These buffers were spiked with 300 ng mL⁻¹ of the aminoglycosides. After the 90 min extraction, signals were not obtained therefore results were not included. This result likely means that no aminoglycosides were extracted from the buffered samples. The cause is likely that metal ions from the buffer salt chelate with the aminoglyocsides' amino and hydroxyl groups. This would then lead to obstruction of the active functional groups of the aminoglycosides that would be capable of interacting with the extraction phase, resulting in no extraction of the analytes which in turn shows no responses of the analytes. The above experiment and associated literature referenced also concludes that the addition of the different salt concentrations is a detriment to the extraction efficiency of the aminoglycosides in an aqueous medium which is in line with literature. Therefore, no experiment was examined to check the effect of salts.

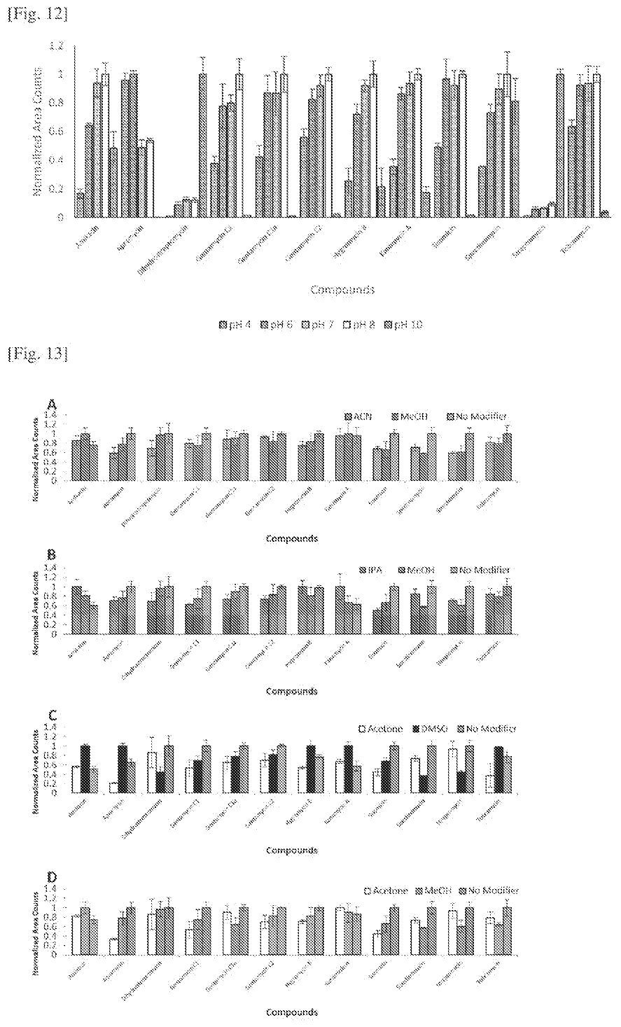

Further pH experiments were performed using an organic acid or base to adjust the pH of the sample to the desired levels as inorganic buffer salts proven to be detrimental for the extraction of aminoglycosides. The pH of the spiked aqueous samples were adjusted to 4, 6, 7, 8, and 10 using FA or N,N-diisopropylethylamine accordingly. The 90 min static extractions at the adjusted pH values show significant responses for the aminoglycosides. This confirmed the detrimental effect of the inorganic salt from the buffers used in the failed pH optimization experiments. The results for the effect of varying sample pH are depicted in FIG. 12, with the responses normalized with respect to the condition giving the highest response for an individual compound. The results show that the response of all aminoglycosides increased from a pH 4 to pH 6. Afterward, there is a slight increase in the responses at pH 7 and 8 except for apramycin. Around pH 7 to 8, most aminoglycosides are close to or above the pKa values for their amino groups. Therefore, their respective neutral species populations are higher. Two notable exceptions are dihydrostreptomycin and streptomycin. These two aminoglycosides have an a five-fold increase when the pH was increased further to pH 10. All other aminoglycosides, on the other hand, have a decrease in response when shifting from a pH 8 to 10. This is most likely due to the deprotonation of the hydroxyl groups, therefore leading to a decrease in neutral species. The pKa values of the amino groups for dihydrostreptomycin and streptomycin tend to be higher compared to other aminoglycosides. Based on the response a pH range between 6 to 8 is acceptable as it allows for adequate extractions of all aminoglycosides except for dihydrostreptomycin and streptomycin. Unfortunately, optimizing pH for dihydrostreptomycin and streptomycin will dramatically decrease the response for all other aminoglycosides which is not acceptable.

Results from the pH experiment suggest that pH adjustment alone is not sufficient to obtain reasonable sensitivity for all aminoglycosides from the aqueous sample. An additional parameter is required to increase responses for the aminoglycosides. Therefore, based on Wang et al., who modified the sample with 50% ACN to increase extraction efficiencies, organic modifiers were introduced to modify the spiked aqueous matrix.

In an aqueous matrix, the polarity and solvation effect of water will negatively affect the overall extraction efficiency of aminoglycosides. Therefore, to investigate the effect of these two factors simultaneously and to overcome these effects, different water-miscible organic solvents were used as modifiers. An equal volume of the following organic solvents; acetone, ACN, IPA, MeOH, and DMSO were mixed with equal volumes of water already spiked with 300 ng mL⁻¹ of aminoglycosides. The extraction efficiency of these water-modified matrices was compared with the unmodified spiked water matrix. The results are shown in FIG. 13. Despite having a final concentration of 150 ng mL⁻¹, the modified water matrices tend to show responses similar or higher to the unmodified water matrix which having a final concentration of 300 ng mL⁻¹.

FIG. 13 shows a matrix modification investigation of (A) ACN & MeOH, (B) IPA & MeOH, (C) Acetone & DMSO, and (D) Acetone & MeOH. It is evident from FIG. 13 at (A) that ACN and MeOH, both of which are polar solvents, gave a significant increase in the instrumental response for all of the analytes of interest. This could be attributed to the fact that both organic modifiers lower the polarity and solvation effect of the aqueous sample (H₂O has a polarity of 10.2), ultimately enhancing the extraction efficiency. To some extent, MeOH shows better responses than ACN as a modifier. The response of the MeOH modified sample with an aminoglycoside concentration of 150 ng mL⁻¹ is comparable to the unmodified aqueous matrix having aminoglycoside concentration of 300 ng mL⁻¹. This indicates that extraction efficiency is enhanced either by MeOH lowering the polarity of water or by MeOH being a protic solvent and having the ability to break the solvation cage between the analytes and water molecules through hydrogen bonding.

To investigate the effect of polarity and solvation closer, another protic solvent, IPA was evaluated as a potential modifier. The response between IPA and MeOH as modifiers were compared in FIG. 13 at (B). The polarity index of IPA and MeOH are 3.9 and 5.1 respectively. The responses of analytes show an increase when using IPA as the modifier compared to MeOH. Being a protic solvent, both modifiers have similar abilities to break the solvation cages, however the lower polarity of IPA lowers the affinity of aminoglycosides to the matrix. This, in turn, leads to a higher extraction efficiency for the IPA modified sample.

To further understand the role of modifiers, aprotic solvents like acetone, and DMSO were used. Both solvents are structurally similar, with the primary difference being the sulfur in DMSO substituted with a carbon for acetone which leads to different polarities. The polarity index of DMSO and acetone are 7.2 and 5.1 respectively. The responses in FIG. 13 at (C) of the analytes generally showed a significant increase when using DMSO as the modifier compared to acetone. DMSO cannot lower the polarity of the sample to the same extent as acetone, based on the polarity index. Instead, DMSO is a well-known solvent for the breaking of a hydrogen bond and solvation/hydration sphere. This result indicates that DMSO enhances extraction efficiency may be primarily by breaking the hydration sphere instead of lowering the polarity.

The above experimental evidence suggests both polarity and solvation/hydration have significant effects on the extraction of the aminoglycosides from water. This has further evidence by comparing analytes response when acetone or MeOH are used as modifiers in FIG. 13 at (D). Both solvents have a polarity index of 5.1. However, MeOH modified samples tend to show a higher response to that of acetone modified samples, despite the same effect regarding lowering polarity.

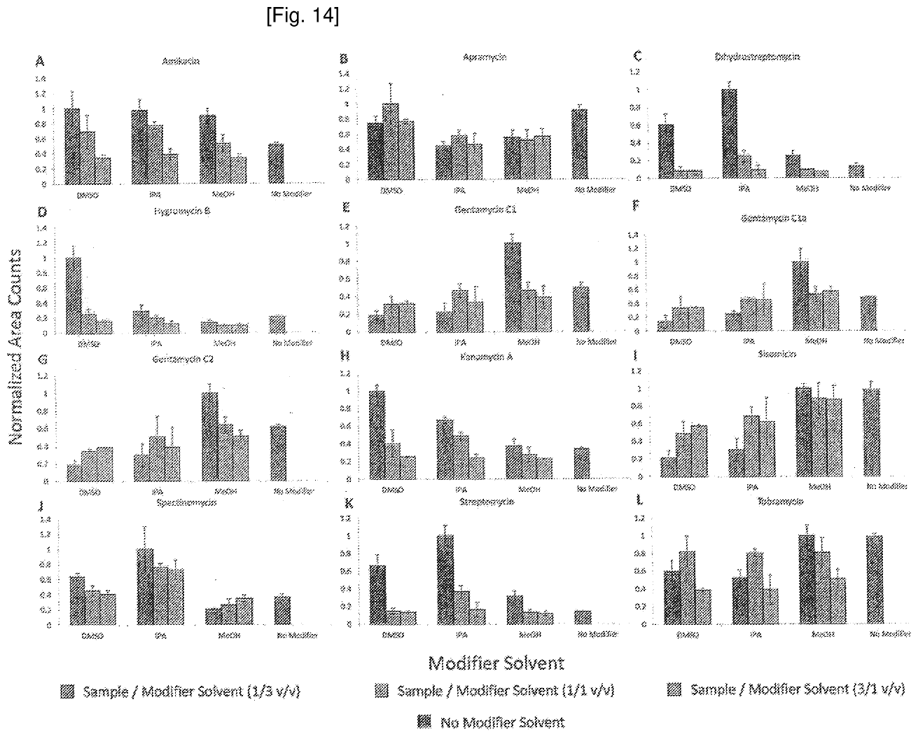

Considering the above results and discussion, it is clear that both solvation and polarity are influential factors and are simultaneously affecting the extraction of aminoglycosides from aqueous samples. Thus, selecting an appropriate matrix modifier is critical for enhancing the performance of the assay. Further optimizations were performed to obtain an optimal composition of modifiers for the screening aminoglycosides by SPME-PESI/MS/MS. These experiments investigated the response of different proportions of DMSO, IPA, and MeOH used to modify the spiked water sample, and better understand how the proportions of modifier solvent to spiked water samples would positively or negatively impact the extraction of aminoglycosides from water. FIG. 14 shows extended Matrix Modification of Water to Enhance Aminoglycoside Extraction of: (A) Amikacin, (B) Apramycin, (C) Dihydrostreptomycin, (D) Hygromycin B, (E) Gentamycin Cl, (F) Gentamycin OA, (G) Gentamycin C2, (H) Kanamycin A, (I) Sisomicin, (J) Spectinomycin, (K) Streptomycin, and (L) Tobramycin. It is evident from FIG. 14 that the quantity of organic modifiers also has a significant impact on the extraction of aminoglycosides. The response of the analytes tends to increase with the quantity of organic modifiers. When the water samples were modified with 3 equivalents of organic solvents, the analytes responses tend to be higher compared to unmodified water sample (300 ng mL⁻¹) despite the concentration of the analytes being a quarter of the concentration of the unmodified samples. Based on the results in FIG. 14 and considering the decrease in polarity and disruption of the solvation sphere around the aminoglycosides, IPA was selected as a suitable modifier over other organic solvents. Using 3 equivalents of IPA as the modifier gave the best results for dihydrostreptomycin, streptomycin, and spectinomycin which had the lowest responses of the aminoglycosides which factored heavily into this decision. DMSO was discarded as it is not being compatible with MS systems and it has a high boiling solvent, leading to long drying times before being used for SPME-PESI-MS/MS. to the MS system.

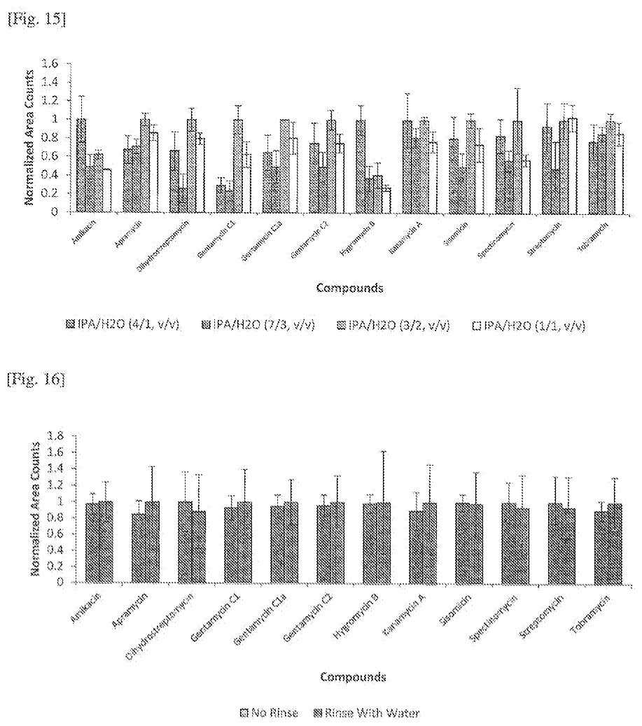

The optimization of desorption solvent is a critical component for SPME-PESI-MS/MS as the desorption solvent must balance the following factors: optimum desorption of the analytes from the coating, the amount of desorption solvent loaded onto the coated PESI probe from the sample plate by the picking process, and the compatibility with the ESI process. Based on the results in FIG. 15, the optimal desorption solvent was determined IPA/H₂O (v/v3/2)+0.1% FA. This desorption solvent gave the best response overall especially for the aminoglycosides that tended to give lower responses. The FA plays a pivotal role for desorption as it should be noted that the extraction matrix was composed of IPA/H₂O (v/v 3/1). The mechanism of desorption hinges on the acidic desorption solvent protonating the amino groups of the aminoglycosides leading to the disruption of the interactions between the coating and analytes.

The effect of rinsing before the desorption/ionization step on the response produced by the SPME-PESI-MS/MS was investigated using water as rising solvent. This investigation was conducted to check whether the aminoglycosides would remain onto the coating after a rinsing step or not. The results of this investigation are compiled in FIG. 16. The results show that rinsing with water did not show any significant decrease in signal when compared to no rinsing. This provides evidence that the aminoglycosides were strongly bound onto the coating of the coated PESI probes.

In this work, the qualitative screening parameters like different extraction and desorption conditions of aminoglycosides were investigated for SPME-PESI-MS/MS. It was found that a pH range between 6 &#8211; 8, with no salt, and the addition of IPA as an organic modifier gave optimal responses. The optimal desorption solvent found was IPA/H₂O (v/v 3/2)+0.1% FA. Based on these parameters, the 12 aminoglycosides spiked in water were able to be screened.

### Example 5

In Example 5, LC-MS-grade acetonitrile (ACN), isopropanol (IPA), and methanol (MeOH) were purchased from Fischer Scientific (Mississauga, Canada), while formic acid (FA), sodium chloride, potassium chloride, potassium phosphate monobasic, sodium phosphate dibasic, hydrochloric acid, and HPLC-grade MeOH were purchased from Sigma Aldrich. In addition, divinylbenzene, N-vinylpyrrolidone, and 2,2-Azobis (isobutyronitrile) were purchased for the synthesis of 1.3 &micro;m hydrophilic-lipophilic particles (HLB). The following analytical standards and their deuterated analogues were purchased from Cerilliant Corporation (Round Rock, Tex., USA): buprenorphine, codeine, diazepam, fentanyl, lorazepam, nordiazepam, oxazepam, propranolol, buprenorphine-d₄, codeine-d₃, diazepam-d₅, fentanyl-d₅, lorazepam-d₄, nordiazepam-d₅, and propranolol-d₇. The deuterated analogues were used for internal standard correction when applicable; the lone exception to this was oxazepam, where nordiazepam-d5 was used when applicable. Frozen, pooled gender, non-filtered human plasma with K₂EDTA as the anticoagulating agent was purchased from Bioreclamation IVT (Westbury, N.Y., USA). The PESI probes and sample plates were donated by Shimadzu Corporation (Kyoto, Japan).

HLB synthesis and PBS preparation were performed. An in-house-built stage equipped with a motor (MTS50/M-Z8E, 50 mm) from ThorLabs Inc. (Newton, Mass., USA) was used to dip coat the PESI probes. The LC-MS/MS experiments were conducted on a Shimadzu LCMS 8060 (Kyoto, Japan) triple quadrupole mass spectrometer, while liquid chromatography was performed using a Shimadzu LC-30AD pump (Kyoto, Japan) and a Phenomenex Kinetex PFP column (2.1×100 mm) with a 1.7 &micro;m particle size (Phenomenex, Torrance, Calif., USA) for separation. Information about the analytes and the transitions that were used for the LC-MS/MS and SPME-PESI-MS/MS experiments can be found in Table S1. Further information about the LC-MS/MS experimental conditions can be found in Table S2 and Table S3. The SPME-PESI-MS/MS experiments were conducted on a Shimadzu LCMS 8060 (Kyoto, Japan) triple quadrupole mass spectrometer with a DPiMS-8060 interface (Kyoto, Japan). Further information about the SPME-MS/MS experimental conditions can be found in Table S4 and Table S5.

LC-MS/MS experiments were conducted using a Shimadzu LC-30AD pump (Kyoto, Japan) and a Shimadzu LCMS 8060 (Kyoto, Japan) triple quadrupole mass spectrometer. Detailed information about the instruments and the optimized LC and MS/MS parameters are provided in Tables S1-S3 below.

TABLE S1
Analyte Information.

| | | | | Precursor | Product | Q1 Pre- | Collision | Q3 Pre-Bias |
|---|---|---|---|---|---|---|---|---|
| # | Compound | Internal Standard | LogP | Ion (m/t) | Ion (m/z) | Bias (V) | Energy | (V) |
| 1 | Buprenorphine | Buprenorphine-d₄ | 4.98 | 468.3 | 55.1 | −11 | −50 | −21 |
| 1 | Buprenorphine | Buprenorphine-d₄ | 4.98 | 468.3 | 396.3 | −11 | −39 | −30 |
| 2 | Buprenorphine-d₆ | | | 472.3 | 59.2 | −11 | −52 | −22 |
| 3 | Codeine | Codeine-d₃ | 1.39 | 300.2 | 165.2 | −11 | −42 | −11 |
| 3 | Codeine | Codeine-d₃ | 1.39 | 300.2 | 215.2 | −11 | −24 | −15 |
| 4 | Codeine-d₃ | | | 303 2 | 215.1 | −11 | −26 | −15 |
| 5 | Diazepam | Diazepam-d₅ | 2.82 | 285.0 | 193.1 | −11 | −30 | −13 |
| 5 | Diazepam | Diazepam-d₅ | 2.82 | 285.0 | 154.1 | −11 | −27 | −16 |
| 6 | Diazepam-d₅ | | | 2903 | 198 1 | −11 | −32 | −21 |
| 7 | Fentanyl | Fentanyl-d₅ | 4.05 | 337.2 | 188.3 | −10 | −24 | −13 |
| 7 | Fentanyl | Fentanyl-d₅ | 4.05 | 337.2 | 105.1 | −10 | −38 | −20 |
| 8 | Fentanyl-d₅ | | | 342.3 | 188.2 | −13 | −24 | −13 |
| 9 | Lorazepam | Lorazepam-d₄ | 2.39 | 321.0 | 275.1 | −12 | −21 | −20 |
| 9 | Lorazepam | Lorazepam-d₄ | 2.39 | 321.0 | 229.1 | −12 | −29 | −24 |
| 10 | Lorazepam-d₄ | | | 325.2 | 279.0 | −10 | −24 | −19 |
| 11 | Nordiazepam | Nordiazepam-d₅ | 2.79 | 271.0 | 140.1 | −10 | −26 | 25 |
| 11 | Nordiazepam | Nordiazepam-d₅ | 2.79 | 271.0 | 165.1 | −10 | −27 | −17 |
| 12 | Nordiazepam-d₅ | | | 276.2 | 213.2 | −11 | −27 | −15- |
| 13 | Oxazepam | Nordiazepam-d₅ | 2.24 | 286.9 | 241.1 | −11 | −24 | −16 |
| 13 | Oxazepam | Nordiazepam-d₅ | 2.24 | 286.9 | 269.1 | −14 | −16 | −19 |
| 14 | Propranolol | Propranolol-d₇ | 3.48 | 260.4 | 116.2 | −10 | −17 | −22 |
| 14 | Propranolol | Propranolol-d₇ | 3.48 | 250.4 | 183.1 | −10 | −18 | −12 |
| 15 | Propranolol-d₇ | | | 267.2 | 116.2 | −10 | −19 | −12 |

Note
that the bolded product ions are the quantitative ions. Pause time and dwell time for all compounds were both 1 msec.

TABLE S2
LC conditions.

| | Optimized LC conditions | | |
|---|---|---|---|
| Column | Phenomenex Kinetex PFP Column | | |
| | 2.1 × 100 mm, 1.7 μm particle size, 100Å Torrance, CA, USA | | |
| Mobile phase | A: water with 0.1% formic acid | | |
| | B: methanol/acetonitrile (v/v 7/3) with 0.1% formic acid | | |
| Flow rate | 300 μL min⁻¹ | | |
| Column | 35° C. | | |
| temperature | | | |
| Autosampler | 4° C. | | |
| temperature | | | |
| Sample | 3 μL for PBS extracts | | |
| injection | 6 μL for PBS extracts | | |
| volume | | | |
| | Time (min) | % A | % B |
| Gradient | 0.0 | 90 | 10 |
| | 1.0 | 90 | 10 |
| | 7.0 | 0 | 100 |
| | 9.0 | 0 | 100 |
| | 9.2 | 90 | 10 |
| | 11.0 | 90 | 10 |

TABLE S3
MS conditions for LC-MS/MS.
MS parameters on the LCMS 8060

| | |
|---|---|
| Ionization mode | ESI |
| Interface voltage | 4.0 kV (positive) |
| Interface temperature | 300° C. |
| Desolvation line temperature | 250° C. |
| Heating block temperature | 400° C. |
| Nebulizing gas flow | 3.0 L/min |
| Drying gas flow | 10.0 L/min |
| Heating gas flow | 10.0 L/min |
| Collision gas and pressure | Argon, 270 kPa |
| Dwell time | 10 ms |

TABLE S4
DPi-8060 Parameters for PESI-MS/MS.

| | MS parameters on the LCMS 8060 | | |
|---|---|---|---|
| Extraction Mode | Top Position | −44.00 | mm |
| | Bottom Position | −45.00 | mm |
| | Count | 1 | |
| | Probe Speed | 250.00 | mm/s |
| | Probe Acceleration | 1.00 | G |
| Analysis Mode | Ionization Position | −37.00 | mm |
| | Outage Time (Ionization Position) | 200 | ms |
| | Sample Position | −46.00 | mm |
| | Outage Time (Sample Position) | 50 | ms |
| | Probe Speed | 250 | mm/s |
| | Probe Acceleration | 0.63 | G |

TABLE S5
Optimized MS conditions for SPME-PESI-MS/MS.
MS parameters on the LCMS 8060

| | |
|---|---|
| Ionization mode | ESI |
| Interface voltage | 23 kV (positive) |
| Desolvation line temperature | 250° C. |
| Heating block temperature | 30° C. |
| Collision gas and pressure | Argon, 270 kPa |
| Pause time | 1 ms |
| Dwell time | 1 ms |

TABLE S6
Decreases in signal between two consecutive SPME-PESI-MS/MS experiments using the same
probe. SPME-PESI probes were used to perform 90 min extractions from 300 μL of PBS under
static conditions (spiked with 10 ng/mL of standards), followed by two consecutive SPME-PESI-
MS/MS runs using two fresh aliquots of 10 μL of IPA/H₂O (1/1 v/v) + 0.1% FA.
Decrease in Signal (%)

| Codeine | Lorazepam | Oxazepam | Nordiazepam | Diazepam | Propranolol | Buprenorphine | Fentanyl |
|---|---|---|---|---|---|---|---|
| 77 | 85 | 81 | 80 | 80 | 81 | 89 | 81 |

$Decrease in Signal = ( 1 - \frac{Area count of SPME - PESI - \frac{MS}{MS} run 2}{Area count of SPME - PESI - \frac{MS}{MS} run 1} ) * 100 \%$

The autosampler was thermostated to 4&#730;C and programmed to inject 3 &micro;L or 6 &micro;L of PBS or plasma extracted samples, respectively. A Phenomenex (Torrance, Calif., USA) Kinetex PFP column (2.1×100 mm) with a 1.7 &micro;m particle size was used for separation. The column oven was thermostated to 35&#730;C, and a flow rate of 300 &micro;L/min was used. Mobile phase A was comprised of water, while mobile phase B was comprised of MeOH/ACN (v/v, 7/3); both mobile phases contained 0.1% formic acid. The gradient was run at 10% B for 1.0 min, and then linearly ramped to 100% B until 7.0 min and held there until 9.0 min. The column was then returned to 10% B at 9.2 min, where it was allowed to re-equilibrate until 11.0 min.

SPME-PESI-MS/MS experiments were conducted using a Shimadzu DPiMS-8060 interface (Kyoto, Japan) and a Shimadzu LCMS 8060 (Kyoto, Japan) mass spectrometer. Detailed information about the instruments and the optimized DPiMS-8060 interface and MS/MS parameters are provided in Tables S1, S4, and S5. The outage time in the sample position was 50 ms, and the outage time in the ionization position was 200 ms. An interface voltage of 2.3 kV was applied when the probe was in the ionization position.

Seven percent (weight/volume) polyacrylonitrile (PAN) was mixed with dimethyl-formamide (DMF) to create the coating binder. Next, a slurry consisting of 9.2% 1.3 &micro;m HLB particles, 87.9% coating binder, and 2.8% glycerol by weight was prepared. The PESI probes were etched via sonication in diluted HCl (7.4%) for 15 min. The probes were then sonicated in water for 20 min, and then in MeOH for another 20 min. Following sonication, the etched probes were dried in an oven and then dip-coated with the 1 &micro;m HLB/PAN slurry up to a length of 2 mm using an in-house built stage. After dip-coating, the probes were dried in a GC oven at 90&#730;C. This dip-coating process took place on the same day as the probes were etched and was repeated until a coating thickness radius of 6.5 &micro;m had been achieved. Thus, the coating on the SPME-PESI probes used in these experiments was 2 mm in length and 6.5 &micro;m in thickness. Before any extractions were performed, the SPME-PESI probes were cleaned with a solvent mixture of MeOH/ACN/IPA (v/v/v 2/1/1) for 15 min and conditioned with a solvent mixture of MeOH/H₂O (v/v 1/1) for 15 min.

An extraction time profile for the SPME-PESI probes was constructed using aliquots of 300 &micro;L PBS spiked with 10 ng mL⁻¹ of standards that had been statically extracted at 10, 30, 60, 90, and 120 min. Extraction was followed by a 3 s rinse and a 30 min static desorption in 50 &micro;L MeOH/ACN (v/v 4/1).

A desorption time profile for the SPME-PESI probes was constructed using aliquots of 300 &micro;L PBS spiked with 10 ng/mL of standards that had been statically extracted at 90 min, rinsed with H₂O for 3 s, and desorbed statically in 50 &micro;L MeOH/ACN (v/v 4/1) at 10, 30, 45, 60, and 75 min. A second desorption was immediately conducted with another 50 &micro;L of MeOH/ACN (v/v 4/1) for 75 min in order to assess the carryover of analytes on the SPME-PESI probes after the first desorption.

Intra-probe reproducibility was tested via five cycles of extraction and desorption using aliquots of 300 &micro;L of PBS spiked with 10 ng mL⁻¹ of standards. Interprobe reproducibility was determined by grouping the probes from the intra-probe reproducibility test based on their extraction and desorption cycles.

The desorption solution used in the SPME-PESI-MS/MS trials was optimized by extracting aliquots of 300 &micro;L PBS spiked with 10 ng mL⁻¹ standards for 90 min, followed by a rinse with H₂O for 3 s. After rinsing, the SPME-PESI probe was placed into the DPiMS-8060 interface, and 10 &micro;L of desorption solution was applied to the sample plate. Finally, an SPME-PESI-MS/MS run was conducted. The tested desorption solutions varied in their ratios of water to organic solvent with 0.1% formic acid. The organic solvents used in these optimization trials were ACN, IPA, and MeOH.

All plasma samples that had been spiked with analytes were incubated overnight in a refrigerator at 4&#730;C to allow for adequate binding between the analytes and the plasma. An extraction time profile for the SPME-PESI probes was constructed using aliquots of 30 &micro;L plasma spiked with 10 ng mL⁻¹ of standards that had been statically extracted at 10, 30, 45, 60, 75, and 90 min. Extraction was followed by a 3 s rinse and a 30 min static desorption in 50 &micro;L MeOH/ACN (v/v 4/1) for LC-MS/MS analysis.

Calibration curves were constructed by using SPME-PESI-MS/MS to extract 30 &micro;L of plasma with 10 ng mL⁻¹ of internal standards and the following concentrations of standards: 1, 5, 10, 25, 50, 75, 100 ng mL⁻¹. Precision and accuracy were determined using three different QC levels, which consisted of plasma spiked with the following concentrations of standards: 3, 30, and 90 ng mL⁻¹. Five replicates were used for each calibration and QC level.

Extraction time profiles were determined via static extractions from PBS spiked with 10 ng mL⁻¹ of standards at time points ranging from 10-120 min (FIG. 4), with the results indicating 90 min as the optimal extraction time. Although the compounds did not reach equilibrium at this time point, an extraction time of 90 min provided high sensitivity and allowed for the completion of five consecutive extraction and desorption cycles in order to assess inter- and intra-probe reproducibility. While the use of agitation would result in a shorter extraction time, it was not considered in this work, as it would increase experimental complexity. The desorption time profile was determined via the static extraction of spiked PBS for 90 min, followed by desorption for 10, 30, 45, 60, and 75 min. A second static desorption step was then carried out to assess the carryover of analytes. The results of the desorption time profile experiments showed that all analytes were desorbed quantitatively at 10 min; however, the carryover tests showed that all compounds had carryover percentages of 3.5% or less, with the exception of propranolol and buprenorphine, which had relatively high carryover percentages of 5.0 and 5.3%, respectively. Therefore, 30 min was selected as the optimal desorption time, as all compounds had carryover at or under 3.2% at this time point.

Intra-probe reproducibility was determined via five consecutive extraction and desorption cycles with a 90 min extraction time and a 30 min desorption time in order to assess the probes' stability and reusability. The results indicated excellent intraprobe reproducibility, with 34 instances wherein RSDs were 10% or less, 4 instances wherein RSDs were between 10-15%, and two instances where they were between 15-20% (Table 5.1). In Table 5.1, intra-probe reproducibility of 2 mm coated PESI probes determined by performing five extraction and desorption cycles with five different probes. Extractions were performed for 90 min in 300 &micro;L of PBS (spiked with 10 ng mL⁻¹ of standards in Table S1), and desorption was conducted for 30 min in 50 &micro;L of MeOH/ACN (1/1 v/v). Intra-probe reproducibility was assessed using the RSDs between the area counts obtained from the chromatograms for the same probe. Inter-probe reproducibility was determined by comparing each probe's results for each extraction-desorption cycle during the intra-probe reproducibility tests. The inter-probe reproducibility results showed good reproducibility for the etching and coating process, with 26 instances wherein RSDs were 10% or less, 11 instances wherein RSDs were between 10-15%, 6 instances wherein RSDs were between 15-20%, and one instance where the RSD was 21% (Table 5.2). In Table 5.2, interprobe reproducibility of 2 mm coated PESI probes derived from the raw data in Table 1. The raw data were grouped by extraction-desorption cycle rather than by probe. Extractions were performed for 90 min in 300 &micro;L of PBS (spiked with 10 ng mL⁻¹ of standards in Table S1), and desorption was conducted for 30 min in 50 &micro;L of MeOH/ACN (1/1 v/v). Inter-probe reproducibility was assessed using the RSD between the area counts obtained from the chromatograms for the same extraction and desorption cycle.

TABLE 5.1

| Probe | RSD (%) n = 5 | | | | | | | |
|---|---|---|---|---|---|---|---|---|
| Number | Buprenorphine | Codeine | Diazepam | Fentanvl | Lorazepam | Nordazepam | Oxazepam | Propranolol |
| 1 | 16 | 10 | 6 | 8 | 4 | 5 | 4 | 6 |
| 2 | 12 | 3 | 7 | 9 | 5 | 6 | 6 | 8 |
| 3 | 7 | 10 | 9 | 10 | 7 | 9 | 8 | 9 |
| 4 | 6 | 15 | 5 | 4 | 10 | 8 | 10 | 7 |
| 5 | 9 | 20 | 5 | 4 | 11 | 6 | 11 | 6 |

TABLE 5.2

| Extraction | | | | | | | | |
|---|---|---|---|---|---|---|---|---|
| Cycle | RSD (%) n = 5 | | | | | | | |
| Number | Buprenorphine | Codeine | Diazepam | Fentanvl | Lorazepam | Nordazepam | Oxazepam | Propranolol |
| 1 | 7 | 14 | 7 | 6 | 7 | 7 | 6 | 6 |
| 2 | 5 | 20 | 8 | 7 | 14 | 10 | 13 | 8 |
| 3 | 15 | 21 | 14 | 15 | 15 | 14 | 16 | 15 |
| 4 | 11 | 7 | 9 | 11 | 6 | 9 | 7 | 9 |
| 5 | 7 | 8 | 3 | 4 | 4 | 3 | 4 | 5 |

Notably, the intra- and inter-reproducibility results for the SPME-PESI probes were equal to or lower than the values for SPME mini tips found in the literature. For instance, Vasiljevic et al. assessed the intra-tip reproducibility of SPME mini tips by evaluating the RSDs of five extraction and desorption cycles using 200 ng mL⁻¹ of diazepam, nordiazepam, oxazepam, and lorazepam. Their results showed that only 7 of the 20 RSDs for these compounds were 10%; in contrast, 18 out of the 20 RSDs for these compounds were 10% or less with the SPME-PESI probes. With regards to inter-tip reproducibility, the lowest RSD for diazepam, lorazepam, nordiazepam and oxazepam was 18% with the SPME mini tips, while the highest RSD for these compounds was 16% with the SPME-PESI probes.

With the optimal extraction conditions for SPME-PESI-MS/MS having been identified, it was next necessary to optimize the desorption solvent. To this end, the following desorption solutions were tested: ACN/H₂O (v/v 9/1), ACN/H₂O (v/v 7/3), ACN/H₂O (v/v 1/1), IPA/H₂O (v/v 9/1), IPA/H₂O (v/v 7/3), IPA/H₂O (v/v 3/2), IPA/H₂O (v/v 1/1), IPA/H₂O (v/v 2/3), MeOH/H₂O (v/v 9/1), MeOH/H₂O (v/v 7/3), and MeOH/H₂O (v/v 1/1). Note that 0.1% FA was added as a modifier to all of the above-listed solvents. FIG. 5 shows the results of these experiments using the normalized area counts, which were performed by dividing the area counts for all desorption solvents for a particular compound by the desorption solvent that produced the highest average area count. FIG. 5 does not include data for ACN/H₂O (v/v 9/1), ACN/H₂O (v/v 7/3), ACN/H₂O (v/v 1/1), and IPA: H₂O (v/v 9/1) due to inconsistencies in the generation of spray events when using these desorption solvents. IPA/H₂O (v/v 1/1)+0.1% FA was chosen as the optimal desorption solvent, as it provided the highest area counts of the eight compounds. Unlike other SPME-based ambient mass spectrometry technologies, such as CBS, the proposed SPME-PESI-MS/MS method uses IPA as an organic solvent rather than MeOH. The amount of desorption solvent applied onto the SPME-PESI probe via the repetitive pick-and-spray method is heavily influenced by the surface tension and viscosity of the desorption solvent; however, the solvent is typically in low pL volumes. Yoshimura et al.'s investigation found a positive correlation between increases in surface tension and viscosity and increases in the volume of sample picked and retained on the surface of a PESI probe. The desorption solvent must also be able to sufficiently wet the coating of the SPME-PESI probe in order to allow for adequate analyte transfer from the coating into the desorption solvent.

FIG. 6 shows the difference between the electrospray patterns of SPME-PESI and uncoated PESI. As shown in FIG. 6 at C, the signal height for the uncoated PESI probes is roughly constant, as the concentration of the spiked IPA/H₂O mixture was relatively constant throughout the experiment. In contrast, when the coated PESI probe was used to pick-and-spray spiked IPA/H₂O mixture aliquoted into the sample plate, the signal height increased until the 0.5 million level and remained constant afterwards (FIG. 6 at B). This initial increase in signal height is associated with the increase in the concentration level of analyte in the coating caused by its repeated extraction from the spiked IPA/H₂O mixture. On the other hand, the signal height in FIG. 6 at A—which is for a coated PESI probe containing extracted analytes from spiked PBS—starts off over 10 times higher than the maximum signal heights in FIG. 5 at B and C, and then decreases throughout the run. It should be emphasized that the spiked sample solvent in FIG. 6 at B and C did not have interferences (i.e., salts), as they were removed during extraction corresponding to FIG. 6 at A. To achieve the same goal with PESI, an appropriate sample-preparation step is required. This decrease was hypothesized to be the result of significant desorption of the analytes that had been extracted onto the coated probe occurred during a single SPME-PESI-MS/MS experiment. To test this hypothesis, extractions were performed from spiked PBS samples under one of two conditions: directly desorbing the probe for LC-MS/MS, or using the probe for one SPME-PESI-MS/MS experiment followed by desorption for LC-MS/MS. Table 5.3 shows the results of this experiment expressed as depletion percentages. In Table 5.3, SPME-PESI-MS/MS desorption experiments were conducted by LC-MS/MS to determine the percentage of analyte lost by an SPME-PESI probe during SPME-PESI-MS/MS experiments. An SPME-PESI probe was used to perform extractions from 300 &micro;L of PBS under static conditions (spiked with 10 ng/mL of standards) for 90 min followed by static desorption into 50 &micro;L of MeOH/ACN (4/1 v/v) for 30 min. The extraction step was repeated with the same set of probes then underwent SPME-PESI-MS/MS using 10 &micro;L of IPA/H₂O (1/1 v/v)+0.1% FA. The probes then underwent another static desorption step with fresh desorption solution.

Desorption percentages are expressed relative to the area counts given by the coated probes that were directly desorbed for LC-MS/MS. One SPME-PESI-MS/MS run (60 picks) resulted in at least a 45% desorption of a given compound. The sharp decrease in signal height during a single SPME-PESI-MS/MS run is most likely due to a decrease in the concentration of analytes in the coating as the run progresses. This phenomenon is shown in the Table S6, where the decrease in area count in the second SPME-PESI-MS/MS run is expressed relative to the area count in the first SPME-PESI-MS/MS run. As can be seen, the area count for all analytes decreased by at least a 77% in the second SPME-PESI-MS/MS run. Considering the low pL volumes, the desorption solution will have a high concentration of analytes due to the high solvent/extraction phase coefficient, which defines the enrichment factor in this case. This also implies that it is not possible to apply one of the SPME-PESI probes used in these experiments for screening via SPME-PESI-MS/MS followed by confirmation analysis via LC-MS/MS.

The signal shape for SPME-PESI-MS/MS clearly indicates that a single pick-and-spray is not sufficient for the complete desorption of analytes (FIG. 6 at A).

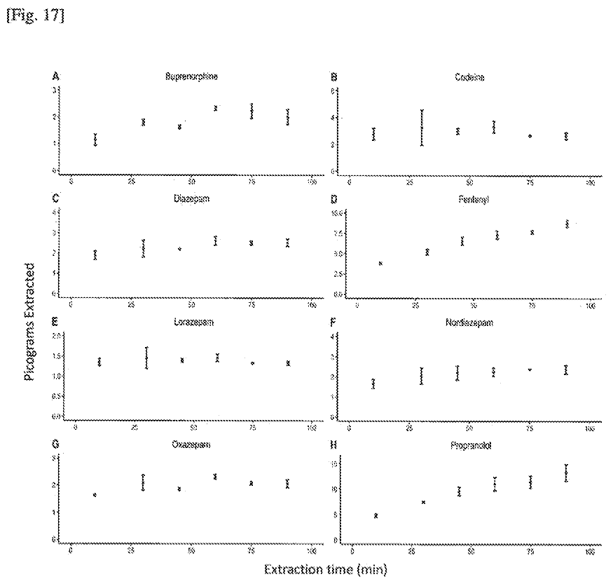

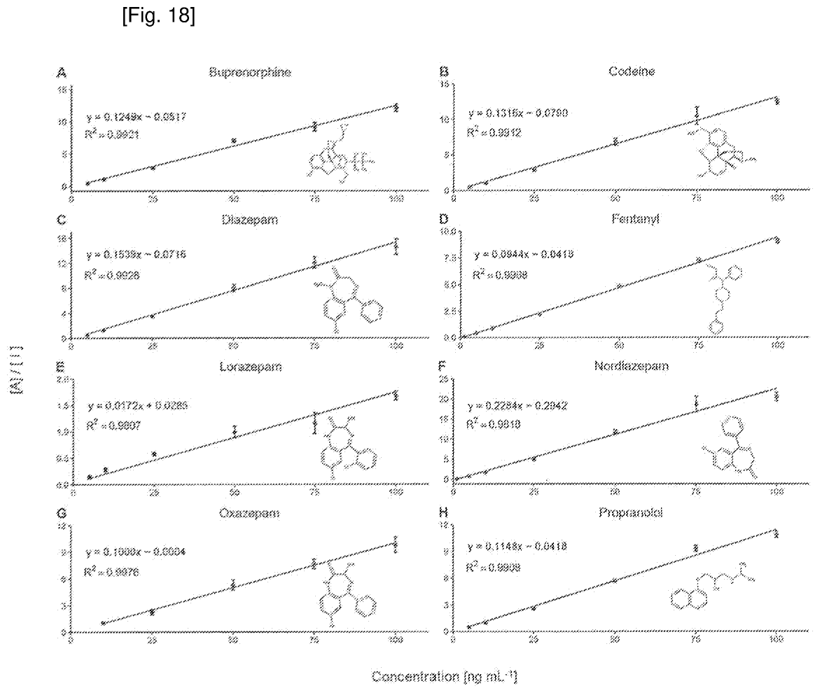

Next, SPME-PESI-MS/MS was applied to quantitate drugs of abuse in a small volume of plasma. Plasma was selected in order to demonstrate SPME-PESI's ability to quantitate analytes in complex matrices in which matrix constituents may bind to the analytes, thus potentially causing ion suppression. Extraction time profiles for 30 &micro;L of spiked plasma were constructed using an equilibration time of approximately 60 min for all analytes (FIG. 17). In FIG. 17, the calibration curve of drugs of abuse using SPME-PESI-MS/MS. Extraction from 30 &micro;L of plasma were conducted under static conditions for 60 min. Corrected calibration curves were constructed using the following spiked concentrations (n=5); 1, 5, 10, 25, 50, 75, 100 ng mL−1. Concentrations below the LLOQ were not plotted. Based on the results, 60 min was also selected as the extraction time, as it corresponded to the highest observed sensitivity. Following this, a calibration curve with seven different calibration levels and five replicates per level was constructed. The constructed calibration curve was weighted by a factor of 1/x. The factors for the line of best fit are listed in Table 5.4, while Table 5.5 presents the other figures of merit. In Table 5.5, the low level was spiked with 3 ng/mL of standards, the middle level was spiked with 30 ng/L of standards, and the high level was spiked with 90 ng mL-1 of standards. All three levels were also spiked with 10 ng/mL of internal standards. Each level had five replicates; for the inter-day assessments, five replicates per day for three days were used. Precision and accuracy assessments used internal-standard-corrected data. FIG. 18 contains the calibration curves for the eight drugs of abuse. Intra- and inter-day precision and accuracy were assessed using three distinct levels—low, middle, and high (3, 30, 90 ng mL⁻¹)—with five replicates per level. FIG. 18 shows the calibration curve of drugs of abuse using SPME-PESI-MS/MS. Extraction from 30 &micro;L of plasma were conducted under static conditions for 60 min. Corrected calibration curves were constructed using the following spiked concentrations (n=5); 1, 5, 10, 25, 50, 75, 100 ng mL−1. Concentrations below the LLOQ were not plotted.

The calibration curves show linearity, with R² values above 0.98 for all of the curves and above 0.99 for six curves. Nordiazepam and fentanyl had a limit of quantitation (LOQ) of 1 ng mL⁻¹, buprenorphine, codeine, diazepam, lorazepam, and propranolol had an LOQ of 5 ng mL⁻¹, and oxazepam had an LOQ of 10 ng mL⁻¹. Intra-day precisions were under 15% for all compounds at concentrations above their respective LOQs; likewise, inter-day precisions were also under 15% for all compounds, with the exception of the middle level of lorazepam and the high level of oxazepam, which were 16% and 27%, respectively. With the exception of the middle level of lorazepam, which was 122%, intra-day accuracies were between 80-120% for all compounds at concentrations above their respective LOQs. Similarly, inter-day accuracies were between 80-120% for all compounds at concentrations above their respective LOQs, with the exception of the middle level of lorazepam, which was 147%. A comparison of the maximum signals in FIG. 6 at A and B shows that SPME-PESI obtained an enhancement factor of over 10 for Fentanyl when compared to spraying desorption solvent spiked at the same level. It should be emphasized that the desorption solvents in SPME-PESI experiments do not have interferences, as these are removed during the extraction procedure. To achieve the same goal of removing the interferences in PESI, an appropriate sample-preparation step would be required, which would add additional step to the procedure.

TABLE 5.3
Percentage Desorption (%) n = 5

| Codeine | Lorazepam | Oxazepam | Nordiazepam | Diazepam | Propranolol | Buprenorphine | Fentanyl |
|---|---|---|---|---|---|---|---|
| 68 | 61 | 57 | 54 | 57 | 46 | 78 | 57 |

$Percent Depletion = ( 1 - \frac{Area count after SPME - PESI - \frac{MS}{MS} runs}{Area count without SPME - PESI - \frac{MS}{MS} run} ) * 100 \%$

TABLE 5.4

| | Linearity | | | | |
|---|---|---|---|---|---|
| | Range | LOQ | | | |
| Compound | (ng/mL) | (ng/mL) | slope | intercept | R\hat{ }2 |
| Buprenorphine | 5-100 | 5 | 0.1249 | −0.0517 | 0.9921 |
| Codeine | 5-100 | 5 | 0.1316 | −0.0790 | 0.9912 |
| Diazepam | 5-100 | 5 | 0.1539 | −0.0716 | 0.9928 |
| Fentanyl | 1-100 | 1 | 0.0944 | −0.0418 | 0.9968 |
| Lorazepam | 5-100 | 5 | 0.0172 | 0.0285 | 0.9807 |
| Nordiazepam | 1-100 | 1 | 0.2284 | −0.2942 | 0.9818 |
| Oxazepam | 10-100 | 10 | 0.1000 | −0.0004 | 0.9976 |
| Propranolol | 5-100 | 5 | 0.1148 | −0.0418 | 0.9908 |

TABLE 5.5

| | Intra-day Precision (%) | | | Inter-day Precision (%) | | | Intra-day Accuracy (%) | | | Inter-day Accuracy (%) | | |
|---|---|---|---|---|---|---|---|---|---|---|---|---|
| Compound | Low | Middle | High | Low | Middle | High | Low | Middle | High | Low | Middle | High |
| Buprenorphine | BQL | 8 | 9 | BQL | 8 | 12 | BQL | 90 | 103 | BQL | 87 | 95 |
| Codeine | BQL | 14 | 7 | BQL | 6 | 8 | BQL | 96 | 101 | BQL | 93 | 103 |
| Diazepam | BQL | 6 | 10 | BQL | 6 | 8 | BQL | 91 | 107 | BQL | 92 | 102 |
| Fentanyl | 4 | 3 | 2 | 4 | 3 | 4 | 93 | 94 | 105 | 94 | 94 | 106 |
| Lorazepam | BQL | 13 | 13 | BQL | 16 | 12 | BQL | 122 | 105 | BQL | 147 | 113 |
| Nordiazepam | 9 | 4 | 6 | 8 | 11 | 8 | 96 | 89 | 98 | 99 | 87 | 95 |
| Oxazepam | BQL | 9 | 11 | BQL | 13 | 27 | BQL | 87 | 99 | BQL | 91 | 110 |
| Propranolol | BQL | 3 | 2 | BQL | 3 | 5 | BQL | 93 | 100 | BQL | 91 | 103 |

BQL is below quantifiable level

SPME-PESI is an ideal tool for clinical applications where minimal invasiveness is required or only extremely small sample volumes can be collected. In addition, SPME-PESI's small dimensions make it an ideal tool for applications wherein preconcentration is not possible via conventional sample-preparation techniques due to limited sample volumes (e.g., in-situ analysis and single-cell analysis of plants and animals), as such techniques would result in the dilution of the target analytes and, consequently, inferior results. Furthermore, SPME-PESI-MS/MS's ability to rapidly determine extracted samples can make it an attractive technique in areas such as prenatal high-throughput screening using multi-well parallel extraction. Moreover, the small dimensions of the SPME-PESI probe may enable non-depletive extraction from small volumes of sample such that free concentrations of analytes and binding constants can even be determined for irreversible binding. The small volume of the coating (only about 6.5 microns thick) results in close-to-maximum microextraction enrichment corresponding to the extraction phase/sample matrix distribution constant (Kfs). In addition, if substantial depletion does not occur, the application of a minute pL volume of desorption solvent could enable further enrichment that may reach the coating/desorption solvent distribution constant (Kfe). Therefore, the overall enrichment factor can be as high as Ksf*Kfe., thus enabling very high determination sensitivities, despite the presence of only a small volume of the sample and the extraction phase.

Even though particular combinations of features are recited in the claims and/or disclosed in the specification, these combinations are not intended to limit the disclosure of possible embodiments. In fact, many of these features may be combined in ways not specifically recited in the claims and/or disclosed in the specification. Although each dependent claim listed below may directly depend on only one claim, the disclosure of possible embodiments includes each dependent claim in combination with every other claim in the claim set.

1.-28. (canceled)

29. A method for identifying a target component of interest in a specimen by probe electrospray ionization mass spectrometry, the method comprising: (1) adsorbing the target component of interest onto an extraction phase for adsorbing the target component of interest from the specimen by immersing a probe into the specimen, wherein the probe is at least partially coated with the extraction phase; (2) removing the probe from the specimen; (3) adhering solvent to the extraction phase; (4) desorbing the target component of the interest into the solvent adhered to the probe from the extraction phase; (5) electrospraying the target component of interest desorbed in the solvent adhered to the probe on the ionization source at atmospheric pressure by applying a voltage to the probe to spray aerosolized ionized droplets out of the probe; and, (6) identifying the small molecule component of interest present in the aerosolized ionized droplets,
wherein the step of adhering solvent includes adhering the solvent to the extraction phase by immersing the probe into the solvent and removing the probe from the solvent.

30. The method according to claim 29, wherein the step of adhering solvent includes spraying the solvent onto the extraction phase.

31. The method according to claim 29, wherein the target component of interest is eluted into the solvent being adhered to at least one of the extraction phase and the probe by repeating the step of adhering.

32. The method according to claim 31, wherein the step of rinsing includes rinsing at least one of the extraction phase and the probe with at least one selected from the group consisting aqueous, organic solvent and mixture thereof.

33. The method according to claim 33, wherein the step of rinsing includes rinsing the probe with water to remove large molecular weight interferences.

34. The method according to claim 31, wherein the step of rinsing includes rinsing the extraction phase and the probe via spray.

35. The method according to claim 28, wherein the solvent further comprises at least one selected from the group consisting of aqueous, organic solvent and mixture thereof

36. The method according to claim 35, wherein an abundance rate of aqueous based on the solvent is from 30 to 70% in weight.

37. The method according to claim 35, wherein the solvent comprises an organic solvent.

38. The method according to claim 37, wherein the organic solvent is alcohol.

39. The method according to claim 38, wherein the alcohol is isopropanol.

40. The method according to claim 35, wherein the solvent further comprises acidic compound.

41. The method according to claim 28, further comprising dipping the probe into the solvent after the step of electrospraying, wherein the step of electrospraying and the step of dipping are repeated.

42. The method according to claim 28, wherein the extraction phase comprises a polymer having solid pores and particles that are sized to adsorb the target components.

43. The method according to claim 28, wherein the extraction phase comprises coating binder to prevent adsorption of non-target components onto the extraction phase.

44. The method according to claim 28, wherein the extraction phase comprises substituted or unsubstituted poly (dimethylsiloxane), polyacrylate, poly (ethylene glycol), poly(divinylbenzene) or polypyrrole.

45. The method according to claim 28, wherein the extraction phase comprises substituted or unsubstituted poly(divinylbenzene).

46. The method according to claim 28, wherein the extraction phase comprises a bioaffinity agent that has a selective cavity.

47. The method according to claim 28, wherein the extraction phase comprises a bioaffinity agent selected from the group consisting of a selective cavity, a molecular recognition moiety, a molecularly imprinted polymer and an immobilized antibody.

48. The method according to claim 28, wherein the specimen is a biological system.

49. The method according to claim 28, wherein the extraction phase comprising a component preventing adsorbing macromolecules.

50. The method according to claim 28, wherein a volume of the extraction phase is in a low nL range and a volume of the solvent adhered to the 53 probe is in a low pL range.

51. A mass spectrometer for identifying a target component of interest in a specimen, the mass spectrometer comprising: a conductive probe being at least partially coated with an extraction phase for adsorbing the target component of interest from the specimen, a container unit which holds solvent inside; a voltage generation unit which applies a voltage to the probe, a displacement unit which causes at least one of the probe arranged extending in the vertical direction and the container unit arranged below the probe, to move vertically so as to cause the probe to immerse into the solvent in the container unit and so as to remove the probe from the solvent unit; wherein, after the solvent is adhered to the probe by the displacement unit and then the extracted target component of interest present adsorbed onto the extraction phase is desorbed into the solvent adhered to the probe, extracted target component of interest desorbed in the solvent adhered to the probe are ionized under atmospheric pressure utilizing the electrospray phenomenon by applying a voltage to the probe by means of the voltage generation unit.

52. A mass spectrometer for identifying a target component of interest in a specimen, the mass spectrometer comprising: a conductive probe being at least partially coated with an extraction phase for adsorbing the target component of interest from the specimen, injector configured to provide misty solvent onto the prove, a voltage generation unit which applies a voltage to the probe, wherein, after the solvent is adhered to the probe by injector configured to provide misty solvent onto the prove and then the extracted target component of interest present adsorbed onto the extraction phase is desorbed into the solvent adhered to the probe, extracted target component of interest desorbed in the solvent adhered to the probe are ionized under atmospheric pressure utilizing the electrospray phenomenon by applying a voltage to the probe by means of the voltage generation unit.

53. The mass spectrometer according to claim 51, further comprising spraying means of the rinsing at least one of the extraction phase and the probe.

54. The mass spectrometer according to claim 52, further comprising spraying means of the rinsing at least one of the extraction phase and the probe.
